(19) United States
(12) Patent Application Publication
(10) Pub. No.: US 2015/0273734 A1
(43) Pub. Date: Oct. 1, 2015

(54) BONDING MEMBER

(71) Applicant: CANON KABUSHIKI KAISHA, Tokyo (JP)

(72) Inventors: Hajime Sato, Tokyo (JP); Yoji Yamamoto, Hachioji-shi (JP)

(21) Appl. No.: 14/673,773

(22) Filed: Mar. 30, 2015

(30) Foreign Application Priority Data
Mar. 31, 2014 (JP) 2014-074573

(51) Int. Cl. B29C 39/00; B29C 39/02; B29C 39/08

(52) U.S. Cl. CPC B29C 39/003; B29C 39/08; B29C 39/026; B29K 2083/00

(57) ABSTRACT

A bonding member includes a base and a protrusion that protrudes from a surface of the base and that has an end face adhering to a substrate with a surface force between the end face and the substrate. Δγ1^{c} and Δγ2^{c} differ from each other so as to satisfy G1^{c}/Δγ1^{c}≠G2^{c}/Δγ2^{c}, where G1^{c} denotes a strain-energy-release rate at a first release portion of the protrusion when a force is exerted in a first direction parallel to the surface, Δγ1^{c} denotes an adhesive energy at the first release portion, G2^{c} denotes a strain-energy-release rate at a second release portion of the protrusion when a force having the same magnitude as the force exerted in the first direction is exerted in a second direction opposite to the first direction, and Δγ2^{c} denotes an adhesive energy at the second release portion.

### BACKGROUND

1. Field of the Invention

The present disclosure relates to a bonding member. The present invention particularly relates to a bonding member that has directionally dependent adhesion force with which it adheres to a substrate with a high level of adhesion force in a particular direction whereas it adheres to a substrate with a low level of adhesion force in another direction.

2. Description of the Related Art

Many bonding members have been required to be highly adhesive, highly durable, or highly heat-resistant and thus have been developed so as to satisfy these demands. From the recycling view point to effectively use limited sources, on the other hand, useful bonding members are those that can be easily released when desired and that are reusable.

Thus, bonding members that have adhesion force that varies to a large extent depending on directions in which a force is exerted and that can strongly adhere to a substrate but is easily releasable from the substrate with an appropriate selection of directions in which a force is exerted, specifically, bonding members that have directionally dependent adhesion force have been required.

Some examples of such bonding members that have a characteristic shape on a surface of a bonding member have been reported.

A bonding member that includes multiple inclined columnar structures having an asymmetric vertical section is disclosed in “Adhesion and Anisotropic Friction Enhancement of Angled Heterogeneous Micro-Fiber Arrays with Spherical and Spatula Tips” written by M. Murphy, B. Aksak, and M. Sitti in Journal of Adhesion Science and Technology, vol. 21, no. 12-13, pp. 1281-1296, 2007. Specifically, “Adhesion and Anisotropic Friction Enhancement of Angled Heterogeneous Micro-Fiber Arrays with Spherical and Spatula Tips” written by M. Murphy, B. Aksak, and M. Sitti in Journal of Adhesion Science and Technology, vol. 21, no. 12-13, pp. 1281-1296, 2007, discloses that the adhesion force that is parallel to the interface has a certain level of directional dependency: the columnar structures have a high level of adhesion force against such a parallel force that pulls the columnar structures whereas the columnar structures have a low level of adhesion force against such a parallel force that compresses the columnar structures.

Japanese Patent Laid-Open No. 2009-70883 discloses a bonding member that has similar inclined columnar structures. This bonding member is said to be relatively easily releasable from a substrate without remaining on the substrate.

On the other hand, “Directional Adhesion for Climbing: Theoretical and Practical Considerations” written by D. Santos, M. Spenko, A. Parness, S. Kim, and M. Cutkosky in Journal of Adhesion Science and Technology, vol. 21, no. 12-13, 1317-1341, 2007, and Japanese Patent Laid-Open No. 2012-245748 have disclosed bonding members each including multiple columnar structures having wedge-shaped tip ends. In each of these bonding members, the directional dependency of the adhesion force is enhanced by utilizing the internal stress that occurs when the wedge-shaped tip ends are deformed and adhere to the substrate.

Such methods are thus disadvantageous because the bonding member has to be pressed against a substrate in advance in order to exert its adhesion force and the bonding member has a low level of adhesion force against a force exerted in a direction perpendicular to the substrate.

Thus, a method different from the method involving forming of wedge-shaped tip ends has been desired to produce a bonding member having directionally dependent adhesion force.

The above-described existing method for causing simply-inclined columnar structures to adhere to a substrate is not capable of enhancing the directional dependency of the adhesion force.

The present invention provides a bonding member that has adhesion force with a high level of directional dependency.

### SUMMARY

A bonding member as disclosed herein includes a base and a protrusion that protrudes from a surface of the base and that has an end face that adheres to a substrate with a surface force between the end face and the substrate. Δγ1^{c} and Δγ2^{c} differ from each other so as to satisfy G1^{c}/Δγ1^{c}≠G2^{c}/Δγ2^{c}, where G1^{c} denotes a strain-energy-release rate at a first release portion of the protrusion when a force is exerted on the protrusion in a first direction parallel to the surface, Δγ1^{c} denotes an adhesive energy at the first release portion, G2^{c} denotes a strain-energy-release rate at a second release portion of the protrusion when a force having the same magnitude as the force exerted in the first direction is exerted on the protrusion in a second direction opposite to the first direction, and Δγ2^{c} denotes an adhesive energy at the second release portion.

Further features of the present invention will become apparent from the following description of exemplary embodiments (with reference to the attached drawings).

### BRIEF DESCRIPTION OF THE DRAWINGS

FIGS. 1A to 1E illustrate the directional dependency of the adhesion force of a bonding member according to an embodiment of the present invention, where FIG. 1A illustrates the direction in which a force is exerted on a bonded composite, FIG. 1B is a cross-sectional view of the bonded composite illustrated in FIG. 1A, FIG. 1C illustrates an example of a symmetric adhesion profile, FIG. 1D illustrates an example of an asymmetric adhesion profile, and FIG. 1E illustrates an example of an adhesion profile of a bonding member having adhesion force with a high level of directional dependency.

FIGS. 2A and 2B illustrate an example of the structure of a bonding member according to an embodiment of the present invention, where FIG. 2A illustrates the state where a force is exerted on the bonding member in a first direction whereas FIG. 2B illustrates the state where a force is exerted on the bonding member in a second direction.

FIGS. 3A and 3B illustrate the reason why the adhesion force of a protrusion has directional dependency as a result of varying the modulus of elasticity of the protrusion, where FIG. 3A illustrates the case where the protrusion has a uniform modulus of elasticity whereas FIG. 3B illustrates the case where the protrusion has a higher modulus of elasticity on a first-direction half than a modulus of elasticity on a second-direction half.

FIGS. 4A and 4B illustrate an example of a protrusion having an asymmetric horizontal cross section, where FIG. 4A illustrates the state where the axis at which the geometrical moment of area is zero is displaced from the middle point between the end portion in the first direction and the end portion in the second direction and FIG. 4B illustrates examples of protrusions each having a horizontal cross section in which the axis at which the geometrical moment of area is zero is displaced to a large extent in the second direction.

FIG. 5 illustrates the reason why the adhesion force has directional dependency as a result of making the horizontal cross section of the protrusion asymmetric.

FIG. 6 illustrates the definition of an imaginary protrusion assumed to have a left-right symmetric vertical cross section.

FIG. 7 illustrates the way how a strain-energy-release rate is calculated in examples and reference examples.

FIG. 8 illustrates the way how the entire model is divided into segments for calculating the strain-energy-release rate in examples and reference examples.

FIG. 9 illustrates the way how the adhesion profile of a protrusion is calculated in examples and reference examples.

FIGS. 10A to 10F illustrate the shapes of analytic models in examples and reference examples, where FIG. 10A illustrates the shape of an analytic model according to an example and a reference example, FIG. 10B illustrates the shape of an analytic model according to another example and another reference example, FIG. 10C illustrates the shape of an analytic model according to another example, FIG. 10D illustrates the shape of an analytic model according to another example and another reference example, FIG. 10E illustrates the shape of an analytic model according to another example, and FIG. 10F illustrates the shape of an analytic model according to another example and another reference example.

FIG. 11 illustrates the result of analysis on the adhesion profile of the protrusion.

FIG. 12 illustrates the result of analysis on the adhesion profile of the protrusion.

FIG. 13 illustrates the result of analysis on the adhesion profile of the protrusion.

FIG. 14 illustrates the result of analysis on the adhesion profile of the protrusion.

FIG. 15 illustrates the result of analysis on the adhesion profile of the protrusion.

FIG. 16 illustrates the result of analysis on the adhesion profile of the protrusion.

FIG. 17 illustrates the result of analysis on the adhesion profile of the protrusion.

FIG. 18 illustrates the result of analysis on the adhesion profile of the protrusion.

FIG. 19 illustrates the result of analysis on the adhesion profile of the protrusion.

FIG. 20 illustrates the result of analysis on the adhesion profile of the protrusion.

FIGS. 21A and 21B illustrate the shape of the protrusion, where FIG. 21A is an image obtained through an observation with a scanning electron microscope (SEM) and FIG. 21B is an image of a cross section obtained through an observation with a focused ion beam micromachining (FIB)-SEM.

FIG. 22 illustrates actual measurement results of the adhesion profile of the protrusion.

FIG. 23 illustrates an image of the protrusion obtained through an observation using a SEM.

FIG. 24 illustrates actual measurement results of the adhesion profile of the protrusion.

FIG. 25 illustrates an image of the protrusion obtained through an observation using a SEM.

FIG. 26 illustrates actual measurement results of the adhesion profile of the protrusion.

FIG. 27 illustrates actual measurement results of the adhesion profile of the bonding member.

FIGS. 28A and 28B illustrate a shape of the protrusion, where FIG. 28A illustrates an image of the protrusion obtained through an observation using a SEM and FIG. 28B illustrates a cross-sectional image obtained through an observation using a FIB-SEM.

FIG. 29 illustrates actual measurement results of the adhesion profile of the protrusion.

FIGS. 30A and 30B illustrate a shape of the protrusion, where FIG. 30A illustrates an image of the protrusion obtained through an observation using a SEM and FIG. 30B illustrates a cross-sectional image obtained through an observation using a FIB-SEM.

FIG. 31 illustrates actual measurement results of the adhesion profile of the bonding member.

FIG. 32 illustrates an image of the protrusion obtained through an observation using a SEM.

FIG. 33 illustrates actual measurement results of the adhesion profile of the protrusion.

FIGS. 34A and 34B illustrate a shape of the protrusion, where FIG. 34A illustrates an image of the protrusion obtained through an observation using a SEM and FIG. 34B illustrates a cross-sectional image obtained through an observation using a FIB-SEM.

FIG. 35 illustrates actual measurement results of the adhesion profile of the protrusion.

FIG. 36 illustrates actual measurement results of the adhesion profile of the bonding member.

### DESCRIPTION OF THE EMBODIMENTS

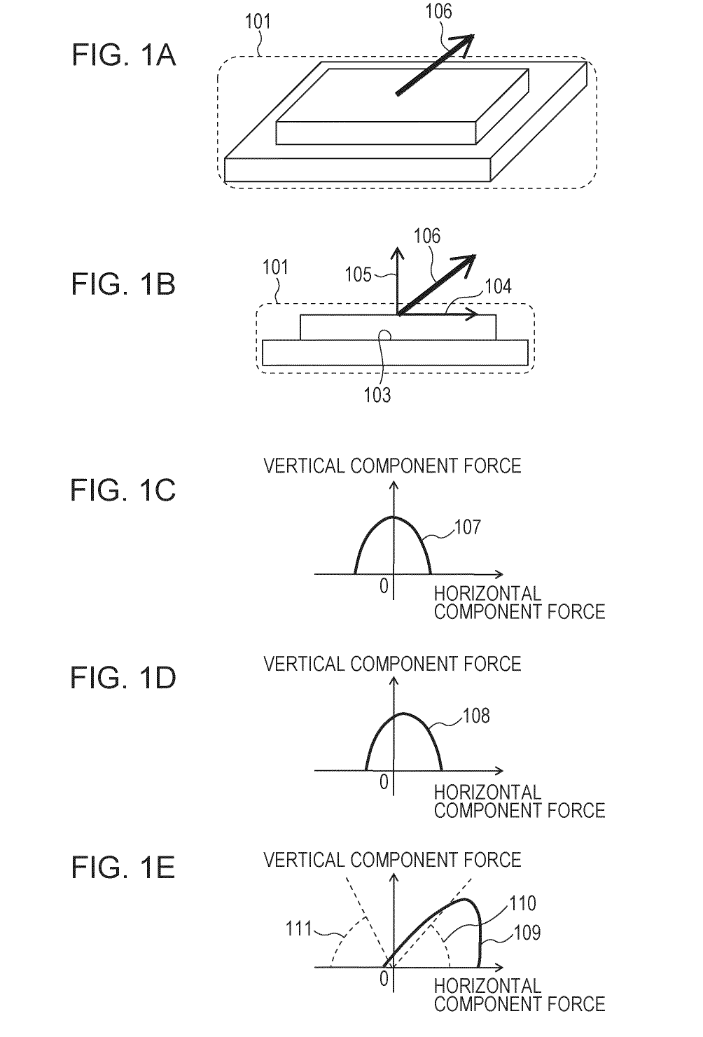

Before a bonding member according to an embodiment of the present invention is specifically described, the definition of the directional dependency of the adhesion force closely relating to the present invention is described referring to FIGS. 1A to 1E.

As illustrated in FIG. 1A, first, adhesion force 106 of a composite 101 constituted of a certain bonding member and a substrate at the time when the composite 101 is pulled in a direction that forms an appropriate angle with respect to an interface 103 is considered. FIG. 1B is a cross-sectional view of the composite 101 illustrated in FIG. 1A.

The adhesion force is further decomposed into a horizontal component force 104, which is parallel to the interface, and a vertical component force 105, which is perpendicular to the interface, and these component forces are plotted on a two-dimensional plane as illustrated in FIGS. 1C to 1E (two-dimensional plots 107 to 109, which are referred to as adhesion profiles, below).

A composite that does not have an asymmetric shape or asymmetric properties in the horizontal direction has an adhesion profile that is uniformly left-right symmetric in the horizontal direction (FIG. 1C).

On the other hand, a composite that has a property that is asymmetric in the horizontal direction may have an adhesion profile asymmetric in the horizontal direction (FIG. 1D). Such a characteristic of an asymmetric adhesion profile is referred to as directional dependency of the adhesion force.

When a composite is appropriately designed so as to have adhesion force with a high level of directional dependency, a bonded composite having an adhesion profile as illustrated in, for example, FIG. 1E can be formed.

Such a composite exerts a high level of adhesion force when pulled at an angle within the range 110 but exerts a low level of adhesion force when pulled in substantially the opposite direction at an angle within the range 111. Specifically, parts of the composite can be caused to adhere to each other with a high level of adhesion force or detached from each other with a low level of adhesion force by selectively exerting a force in an appropriate direction.

The present invention provides a bonding member that has such adhesion force with a high level of directional dependency.

Now, the configuration of a bonding member according to an embodiment of the present invention is described.

A bonding member according to an embodiment of the present invention is a bonding member that includes a base and a protrusion protruding from the surface of the base and that has an end face that adheres to a substrate with the surface force between the end face and the substrate.

The protrusion has a varied modulus of elasticity and/or a varied Poisson's ratio so that G1^{a}/Δγ1^{a}≠G2^{a}/Δγ2^{a} is satisfied where G1^{a} denotes the strain-energy-release rate at a first release portion of the protrusion when a force is exerted on the protrusion in a first direction parallel to the surface, Δγ1^{a} denotes the adhesive energy at the first release portion, G2^{a} denotes the strain-energy-release rate at a second release portion of the protrusion when a force that has the same magnitude as the force exerted in the first direction is exerted on the protrusion in a second direction opposite to the first direction, and Δγ2^{a} denotes the adhesive energy at the second release portion.

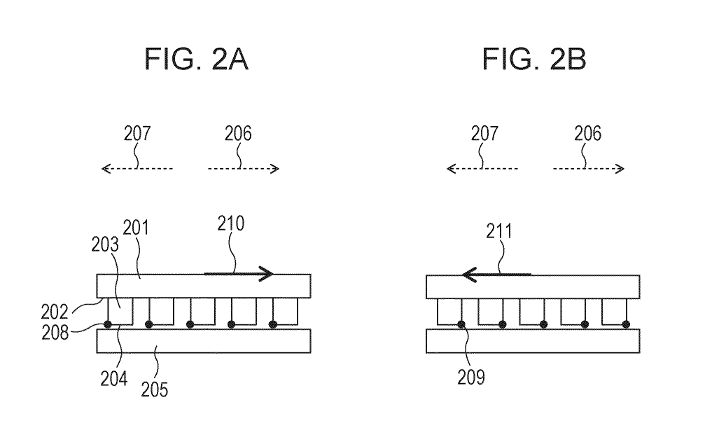

Referring to FIGS. 2A and 2B, the configuration of a bonding member according to an embodiment is described now.

The bonding member includes one or more protrusions 203 protruding from the surface 202 of the base 201. The bonding member adheres to the substrate 205 with the surface force between the end faces 204 of the protrusions and the substrate 205.

Here, the surface force refers to a force, among interactive forces between two objects, that is strongly dependent on the intersurface distance between two objects, not the distance between the gravity centers of two objects. A typical example of the surface force is an intermolecular interactive force.

In the embodiment of the invention, the protrusions 203 are assumed to be elastic structures. Elastic structures are structures that dominantly exhibit elastic behavior over viscous behavior. In such structures, energy dissipation due to the viscous behavior is relatively reduced, whereby such structures are likely to have directionally dependent adhesion force through the mechanism described below.

As a rough indication of such structures, an appropriate example of the dissipation factor tan δ is 0.3 or smaller in view of the observation time (or the time that can be taken for release of the bonding member) or temperature estimated from the practical viewpoint.

Since polymer resins have an appropriate modulus of elasticity and exhibit elastic behavior throughout a wide strain range, they are suitable as components imparting an elastic feature to the protrusion.

Appropriate examples of the material of the protrusion include polydimethylsiloxane (PDMS), polyurethane (PU), polymethyl methacrylate (PMMA) and their analogues.

In the embodiment of the invention, the base 201 and the protrusions 203 can be formed as separate units or an integrated unit.

Even in the case where multiple protrusions are disposed on the surface 202 of the base, the adhesion property of the bonding member is expressed in a sum total of the adhesion properties of individual protrusions. Thus, in order that the bonding member has directionally dependent adhesion force, individual protrusions only have to be appropriately determined in the manner described below.

Specifically, the portion of each protrusion that starts being released from the substrate varies depending on whether a force is exerted on the bonding member in the first direction 206 parallel to the surface 202 of the base or in the second direction 207, opposite to the first direction 206.

Here, the first direction parallel to the surface of the base is a direction literally parallel to the surface, when the surface of the base is a flat surface. When the surface is a curved surface, on the other hand, the direction can be construed as a tangent direction of the curved surface at the position at which the protrusion is disposed. For example, the tangent direction of the curved surface at the position of the protrusion can be specified from the surfaces exposed through adjacent protrusions.

These release portions are defined as a first release portion 208 and a second release portion 209. Such a characteristic of the protrusion in which release portions vary depending on the directions in which a force is exerted results from the feature in which the protrusion adheres to the substrate at its end face with the surface force between the end face and the substrate.

Here, the strain-energy-release rate and the adhesive energy at the first release portion when a force 210 is exerted on the protrusion in the first direction are defined as G1^{a} and Δγ1^{a}, respectively. The strain-energy-release rate and the adhesive energy at the second release portion when a force 211 that has the same magnitude as the force 210 exerted in the first direction is exerted on the protrusion in the second direction are defined as G2^{a} and Δγ2^{a}, respectively.

In the present invention, the strain-energy-release rate is defined as an amount of the elastic strain energy dissipated during the development of a release per unit area. Specifically, the strain-energy-release rate is calculated by dU/dS where dS denotes a minute area and dU denotes the amount of elastic strain energy dissipated during the development of a release per minute area dS.

The adhesive energy is defined as an amount of change of the surface free energy when a new surface is formed by separating from each other two objects A and B that have been bonded together at the interface over a unit area. The adhesive energy is calculated by ΔγA+ΔγB−ΔγAB where the surface free energies of the objects A and B are denoted by ΔγA and ΔγB and the free energy at the interface between the objects A and B is denoted by ΔγAB.

In the bonding member according to the embodiment of the invention, the protrusion has a varied modulus of elasticity and/or a varied Poisson's ratio so that these properties satisfy G1^{a}/Δγ1^{a}≠G2^{a}/Δγ2^{a}.

In the invention, the modulus of elasticity is defined as a proportionality constant between the stress and the strain in elastic deformation (stress/strain). When the modulus of elasticity is used to refer also to the viscous behavior, the modulus of elasticity refers to a storage modulus expressing the effect of storing energy.

The Poisson's ratio is defined as a ratio between the strain in the uniaxial stress direction in which a uniaxial stress is exerted on an object to elastically deform the object and the strain that secondarily occurs in the direction perpendicular to the uniaxial stress direction.

Here, the modulus of elasticity varies depending on the material to a larger extent than the Poisson's ratio, whereby a protrusion having a varied modulus of elasticity is suitably used.

Another conceivable method for varying the modulus of elasticity of the protrusion according to the embodiment is to provide voids in the protrusion since the modulus of elasticity in the voids can be regarded as zero. In the case, for example, where a protrusion has a large number of voids in one region, the average modulus of elasticity in the region decreases, whereby the effect equivalent to that obtained when a protrusion is made of materials having different moduli of elasticity can be substantially obtained.

The reason why the adhesion force has directional dependency in the above-described configuration is as follows.

Firstly, the magnitude of force in the first direction that causes the strain-energy-release rate G1^{a} and the magnitude of force in the second direction that causes the strain-energy-release rate G2^{a} are defined as F, the adhesion force against a force exerted in the first direction is defined as F1, and the adhesion force against a force exerted in the second direction is defined as F2.

The strain-energy-release rate is proportional to the square of the magnitude of the exerted force. Thus, the strain-energy-release rate at the first release portion when the force F1 is exerted on the protrusion in the first direction is defined as G1^{a}(F1/F)² whereas the strain-energy-release rate at the second release portion when the force F2 is exerted on the protrusion in the second direction is defined as G2^{a}(F2/F)².

On the basis of the theory and the analogy in the linear fracture mechanics, the protrusion becomes released from the substrate when the strain-energy-release rate becomes equal to the adhesive energy.

Thus, by solving G1^{a}(F1/F)²=Δγ1^{a} and G2^{a}(F2/F)²=Δγ2^{a}, the adhesion force against a force exerted in the first direction and the adhesion force against a force exerted in the second direction are obtained as F1=F(G1^{a}/Δγ1^{a})^{-1/2} and F2=F(G2^{a}/Δγ2^{a})^{-1/2}, respectively.

Thus, it is understood that, as long as G1^{a}/Δγ1^{a}≠G2^{a}/Δγ2^{a} is satisfied, such an effect that the adhesion force against a force exerted in the first direction is different from the adhesion force against a force exerted in the second direction is exerted.

When G1^{a}/Δγ1^{a}<G2^{a}/Δγ2^{a}, the adhesion force against a force exerted in the first direction is stronger, whereas when G1^{a}/Δγ1^{a}>G2^{a}/Δγ2^{a}, the adhesion force against a force exerted in the second direction is stronger.

The directional dependency of the bonding member increases with increasing difference between G1^{a}/Δγ1^{a} and G2^{a}/Δγ2^{a}. For example, bonding members in which either G1^{a}/Δγ1^{a} or G2^{a}/Δγ2^{a} is at least two times as large as the other are suitable, or bonding members in which either G1^{a}/Δγ1^{a} or G2^{a}/Δγ2^{a} is at least five times as large as the other are more suitable.

The strain-energy-release rates G1^{a} and G2^{a} depend on the shapes, the moduli of elasticity, and the Poisson's ratios of the protrusion and the substrate. The strain-energy-release rates G1^{a} and G2^{a} can be easily calculated on the basis of the above-described information and through structure analysis such as a finite element method or a boundary element method.

Examples of the calculation include a method for obtaining the strain-energy-release rates G1^{a} and G2^{a} from the stress intensity factor, a method for obtaining a J-integral, and a method for extending a minute virtual release (corresponding to a virtual crack extension method in the fracture mechanics).

In the case where the surface force is an intermolecular interactive force, the adhesive energies Δγ1^{a} and Δγ2^{a} depend on the chemical state of the surface.

For example, the surface energies at the release portion of each protrusion and the substrate surface are obtained by contact angle measurement and the adhesive energies Δγ1^{a} and Δγ2^{a} can be obtained by the extended Fowkes theory using values of the dispersion component, the polarity component, and the hydrogen-bond component of the surface energies. Alternatively, the adhesive energies Δγ1^{a} and Δγ2^{a} can be estimated through molecular dynamics simulation if the chemical species of the release portion of the protrusion or the substrate surface are clarified. Instead, the adhesive energies Δγ1^{a} and Δγ2^{a} can be measured through experiments with a method such as Johnson-Kendall-Roberts (JKR) test. Even in the case where the surface force is an interactive force other than the intermolecular interactive force, the adhesive energies Δγ1^{a} and Δγ2^{a} can be obtained by calculating the work required to separate bonded surfaces on which the surface force is exerted from each other to the infinity and then calculating the work per unit bonding area.

Since this embodiment enables estimation or measurement of the strain-energy-release rate and the adhesive energy with the above-described method, this embodiment enables persons having ordinary skill in the art to easily design the distribution of the modulus of elasticity and/or the Poisson's ratio in such a manner that G1^{a}/Δγ1^{a}≠G2^{a}/Δγ2^{a} is satisfied.

As described above, in this embodiment, each protrusion has directionally dependent adhesion force using the characteristic in which the release portion from which the protrusion starts being released from the substrate varies depending on the direction in which a force is exerted on the protrusion.

Thus, an appropriate example of the end face of each protrusion is a flat surface substantially parallel to the substrate.

Such an embodiment has a secondary effect of eliminating the need for strongly pressing the bonding member against the substrate in advance in order for the bonding member to exert its adhesion force and a secondary effect of preventing the adhesion force against a force exerted in a direction perpendicular to the interface from diminishing.

However, the end face of each protrusion does not necessarily have to be a flat surface or completely parallel to the substrate. As long as the release portion of the end face of the protrusion varies depending on the direction in which a force is exerted on the protrusion, such a protrusion can be included within the present invention.

Here, the release portion of the protrusion from which the protrusion starts being released from the substrate upon receipt of a force in a certain direction can be estimated on the basis of, for example, structure analysis.

Specifically, the release portion can be determined by obtaining a portion at which G^{a}/Δγ^{a} is maximum after the distribution of the strain-energy-release rate G^{a} over the end face of the protrusion and the distribution of the adhesive energy Δγ^{a} are obtained. Alternatively, the release portion can be determined through an actual experimental observation. This embodiment thus enables persons having ordinary skill in the art to easily design a protrusion having a release portion that varies depending on the direction in which a force is exerted on the protrusion.

Here, if the direction in which a force is exerted is the first direction, the release portion from which the protrusion is released by the force exerted in the first direction is the first release portion, whereas, if the direction in which a force is exerted is the second direction, the release portion from which the protrusion is released by the force exerted in the second direction is the second release portion.

On the other hand, the shape of a protrusion such as a Kendall release model in which a protrusion dominantly adheres to the substrate at its side surfaces is not suitable for the shape of the protrusion. In this case, once the protrusion adheres to the substrate, the release portion is substantially fixed at the same portion regardless of the direction in which a force is exerted. Thus, it is difficult for such a protrusion to enhance the directional dependency of the adhesion force on the basis of the design idea similar to that of the invention. The invention thus does not include the case where the protrusion adheres to the substrate in the above-described manner.

Here, the reason why the adhesion force of the protrusion has directional dependency by having a varied modulus of elasticity is described as follows.

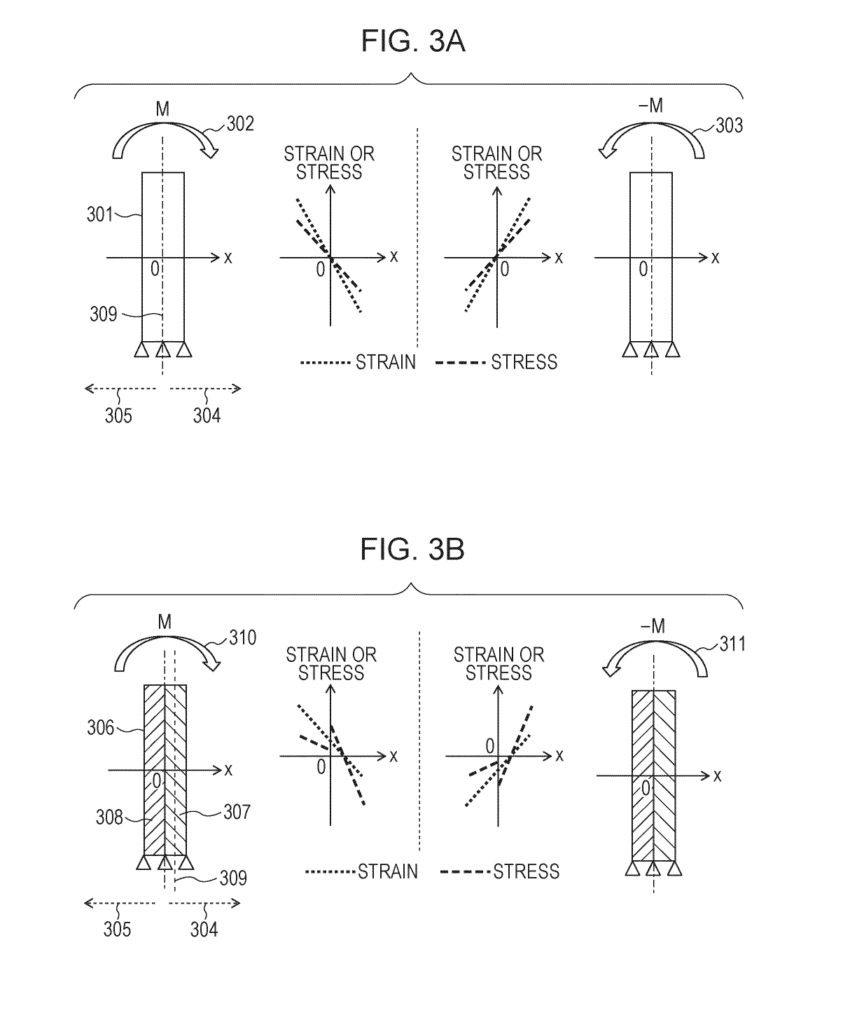

For ease of illustration, a cylindrical protrusion is assumed and the state where an end face (bottom face) of a cylinder 301 is attached to and fixed to the substrate, as illustrated in FIG. 3A is considered.

When a force is exerted on the cylinder in the first direction 304 or the second direction 305, bending moments 302 and 303 are exerted on the cylinder in the opposite directions. When the cylinder has an even modulus of elasticity, the neutral plane 309, in which the strain or stress is zero when the bending moments 302 and 303 are exerted on the end, is located at the center of the protrusion, whereby the absolute values of the strain on the outer side and the inner side of bending are equal to each other. Thus, the maximum tensile stresses are equal regardless of the directions of bending, whereby the adhesion force has no directional dependency.

Subsequently, a cylinder 306 having a varied modulus of elasticity in which, for example, the modulus of elasticity of a first-direction half 307 is larger than the modulus of elasticity of a second-direction half 308 is considered (FIG. 3B).

In this case, the neutral plane 309 is shifted in the first direction. Although the absolute value of the strain in the first-direction end is smaller than that in the second-direction end, the absolute value of the stress in the first-direction end is larger than that in the second-direction end since the effect of the modulus of elasticity is dominant. Because of this effect, the tensile stress against a bending moment 311, with which the cylinder is bent in such a manner that the first-direction half is located outward, becomes larger than the tensile stress against a bending moment 310, with which the cylinder is bent in such a manner that the second-direction half is located outward.

Thus, G1^{a}/Δγ1^{a}<G2^{a}/Δγ2^{a} and the adhesion force of the cylinder has such directional dependency that the adhesion force against the force in the first direction is stronger. If the relationship in the modulus of elasticity between the first-direction half and the second-direction half is reversed, the relationship in the directional dependency of the adhesion force therebetween is also reversed.

In the above-described discussion, the structure is assumed to be cylindrical for ease of illustration. This discussion, however, is expandable naturally to a columnar structure having a cross section other than a cylindrical cross section and also qualitatively to a structure having any shape other than a columnar structure.

Thus, the shape of the protrusion according to the embodiment is not limited to the cylindrical shape.

In addition, the adhesive energy between the protrusion and the substrate is assumed to be uniform. However, even in the case where the adhesive energy therebetween is varied, it is obvious that appropriate designing of the distribution of the modulus of elasticity can vary the stress distribution inside the protrusion and enhance the directional dependency of the adhesion force.

Thus, the embodiment is not limited to the case where the adhesive energy between the protrusion and the substrate is uniform.

As is clear from the above discussion, suitable protrusions are those in which, in view of the distribution of the modulus of elasticity on the horizontal cross section of the protrusion, the average modulus of elasticity in a first-direction half differs from the average modulus of elasticity in a second-direction half. Specifically, it is desirable that the protrusion has a varied modulus of elasticity such that a half of the protrusion differs in average modulus of elasticity from the other half of the protrusion, the two halves being obtained by dividing the protrusion in a direction perpendicular to the first direction.

Further suitable protrusions are those in which a half of the protrusion has an average modulus of elasticity that is at least five times as large as the average modulus of elasticity in the other half of the protrusion. Although suitable examples of protrusions are those that have a modulus of elasticity that exhibits the above-described distribution on the horizontal cross section throughout the entire protrusion, the case where the modulus of elasticity exhibits such a distribution on the horizontal cross section of part of the protrusion is also included in this embodiment.

Suitable examples of the protrusion include a substantially columnar elastic structure. The use of such a structure as a protrusion reduces the rigidity of the protrusion and enhances the pliability of the protrusion with respect to the surface roughness of the substrate, whereby the protrusion can have a high level of adhesion force.

The protrusion can be directly formed by, for example, a fabrication technique using light or heat including photolithography and 3D printing, a self-organization forming technique such as crystal growth, or a machining technique such as shaving. Alternatively, using a mold manufactured by these direct forming techniques to form polymer resins is very efficient in mass production.

The protrusion having a varied modulus of elasticity and/or a varied Poisson's ratio can be manufactured in the following manner.

For example, the modulus of elasticity and/or the Poisson's ratio is varied by physically changing the material properties of part of the protrusion. More specifically, an electron or ion beam or ultraviolet light is applied to part of a protrusion made of a uniform material, to change the material properties of the part of the protrusion, whereby a protrusion having a varied modulus of elasticity and/or a varied Poisson's ratio is obtained.

Alternatively, the modulus of elasticity and/or the Poisson's ratio is varied by forming the protrusion successively using different materials having different moduli of elasticity and/or different Poisson's ratios. More specifically, examples of such a method include a method for bonding separately manufactured materials together and a method for forming a protrusion in two steps by a fabrication technique using light or heat.

Alternatively, the modulus of elasticity and/or the Poisson's ratio can be varied also by allowing the degree of cure or the network structure of chemical chains of a polymer resin which the protrusion is made of to vary in a certain range.

Other conceivable methods include a method for disposing a substance having a different modulus of elasticity and/or a different Poisson's ratio to one side within the protrusion. The sedimentation phenomenon of a substance allows the substance to be disposed to one side within the protrusion.

Which method is most suitable for forming a protrusion may be appropriately determined on the basis of, such as, specifications required for the bonding member.

Another embodiment is a bonding member having directionally dependent adhesion force as a result of making the horizontal cross section of the protrusion asymmetric.

The bonding member according to the embodiment of the present invention includes a protrusion protruding from the surface of a base and an end face of the protrusion adheres to a substrate with a surface force between the end face and the substrate.

In this embodiment, the protrusion has an asymmetric cross section when taken parallel to the surface so that G1^{b}/Δγ1^{b}≠G2^{b}/Δγ2^{b} is satisfied where G1^{b} denotes the strain-energy-release rate at a first release portion of the protrusion when a force is exerted on the protrusion in a first direction parallel to the surface, Δγ1^{b} denotes the adhesive energy at the first release portion, G2^{b} denotes the strain-energy-release rate at a second release portion of the protrusion when a force that has the same magnitude as the force exerted in the first direction is exerted on the protrusion in a second direction opposite to the first direction, and Δγ2^{b} denotes the adhesive energy at the second release portion. Here, the cross section of the protrusion taken parallel to the surface of the base is also referred to as a horizontal cross section.

As described above, the adhesion force against a force exerted in the first direction and the adhesion force against a force exerted in the second direction are obtained as F(G1^{b}/Δγ1^{b})^{-1/2} and F(G2^{b}/Δγ2^{b})^{-1/2}, respectively.

Thus, in this embodiment, when the protrusion has such an asymmetric horizontal cross section that G1^{b}/Δγ1^{b}≠G2^{b}/Δγ2^{b} is satisfied, the adhesion force has such directional dependency that the adhesion force against a force exerted in the first direction is different from the adhesion force against a force exerted in the second direction.

It is suitable that the horizontal cross section of the protrusion taken along the plane parallel (horizontal) to the surface of the base from which the protrusion protrudes is not point-symmetric or line-symmetric with respect to the axis perpendicular to the first direction.

Although it is desirable that the horizontal cross section is asymmetric throughout the entire protrusion, the case where the horizontal cross section is asymmetric in only part of the protrusion is also included in this embodiment.

As described above, the strain-energy-release rate and the adhesive energy can be estimated or measured. Thus, the embodiment enables persons having ordinary skill in the art to easily design the horizontal cross section in such a manner that G1^{b}/Δγ1^{b}≠G2^{b}/Δγ2^{b} is satisfied, whereby the adhesion force can have directional dependency, as described above.

The bonding member increases its directional dependency with increasing difference between G1^{b}/Δγ1^{b} and G2^{b}/Δγ2^{b}. For example, bonding members in which either G1^{b}/Δγ1^{b} or G2^{b}/Δγ2^{b} is at least two times as large as the other are suitable, or bonding members in which either G1^{b}/Δγ1^{b} and G2^{b}/Δγ2^{b} is at least five times as large as the other are more suitable.

Here, the reason why the adhesion force has directional dependency by making the horizontal cross section asymmetric is described as below.

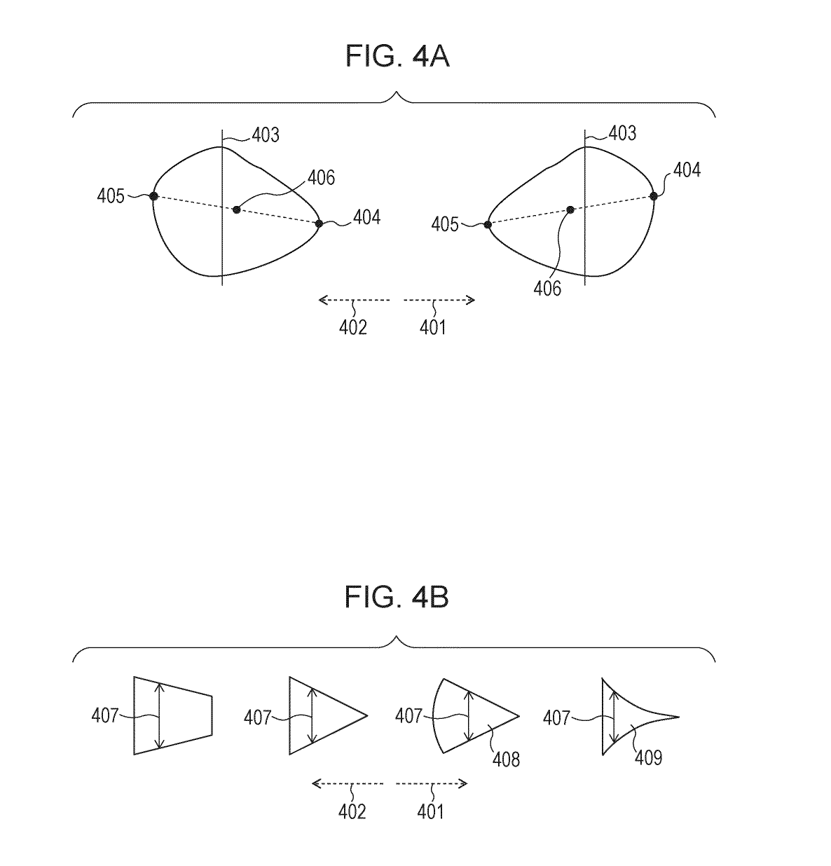

Specifically, as illustrated in FIG. 4A, the adhesion force has directional dependency because the axis 403 that is perpendicular to the first direction 401 and at which the geometrical moment of area of the horizontal cross section is zero is displaced from the middle point 406 between the end portion 404 of the horizontal cross section in the first direction and the end portion 405 of the horizontal cross section in the second direction.

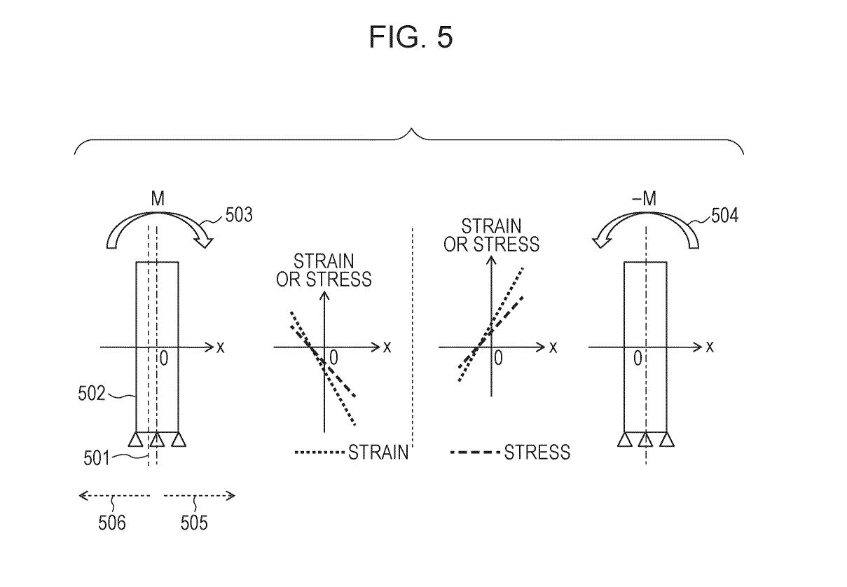

For ease of illustration, the protrusion is assumed to be a columnar structure having an even modulus of elasticity and the protrusion in the state where the end face (bottom face) of the columnar object 502 is bonded and fixed to the substrate as illustrated in FIG. 5 is considered. In FIG. 5, the axis 501 at which the geometrical moment of area is zero is displaced in the second direction 506. Since the modulus of elasticity is assumed to be even, the neutral axis aligns with the axis at which the geometrical moment of area is zero.

When a force is exerted on the columnar object 502 in the first direction 505 or in the second direction 506, bending moments 503 and 504 are exerted on the columnar object 502 in opposite directions. Considering the stress distribution in the case where the bending moments 503 and 504 are exerted on the end portion, the absolute value of the strain on the first-direction end is larger than the absolute value of the strain on the second-direction end.

Thus, the absolute value of the stress on the first-direction end is larger than the absolute value of the stress on the second-direction end.

Because of this effect, the tensile stress against the bending moment 504, with which the columnar object is bent in such a manner that the first-direction half is located outward, becomes larger than the tensile stress against the bending moment 503, with which the columnar object is bent in such a manner that the second-direction half is located outward.

Thus, G1^{b}/Δγ1^{b}<G2^{b}/Δγ2^{b} and the adhesion force of the columnar object has such directional dependency that the adhesion force against a force in the first direction is stronger. If the axis at which the geometrical moment of area is zero is displaced in the first direction, the relationship in the directional dependency of the adhesion force is also reversed.

In the above-described discussion, the protrusion is assumed to have an even modulus of elasticity in order that the axis at which the geometrical moment of area is zero aligns with the neutral axis. In addition, the adhesive energy between the protrusion and the substrate is also assumed to be even.

However, it is obvious that, even in the case where the modulus of elasticity or the adhesive energy is varied, the directional dependency of the adhesion force can be enhanced by appropriately making the horizontal cross section asymmetric with a change of the position of the neutral axis.

Thus, the embodiment is not limited to the case where the modulus of elasticity or the adhesive energy of the protrusion is even. In addition, although the protrusion is assumed to have a columnar shape having a symmetric cross section throughout the entire protrusion, this discussion is qualitatively expandable to a protrusion having any shape and the embodiment is not limited to the columnar protrusion.

As is clear from the above discussion, the directional dependency of the adhesion force is enhanced with increasing amount of displacement of the position of the axis at which the geometrical moment of area of the horizontal cross section is zero. Suitably usable examples are those having an amount of displacement that is at least 5% of the distance between the end portion of the horizontal cross section in the first direction and the end portion of the horizontal cross section in the second direction.

Examples of the horizontal cross section in which the axis at which the geometrical moment of area is zero is displaced to a large extent in the second direction include the shapes illustrated in FIG. 4B and shapes similar to these shapes.

In any of these shapes, the width 407 of the horizontal cross section perpendicular to the first direction 401 substantially constantly increases with increasing distance in the second direction. Thus, the position of the axis at which the geometrical moment of area is zero is effectively displaced in the second direction.

Here, the expression that the width substantially constantly increases may include the case where the width of the horizontal cross section decreases partially, for example, a sector cross section 408. More suitable example is a cross section 409 in which the width of the horizontal cross section substantially exponentially increases with increasing distance in the second direction.

Although it is desirable that the axis at which the geometrical moment of area is zero is displaced toward the same side throughout the entire protrusion, the case where the axis is displaced only in part of the protrusion is also included in this embodiment.

Suitable examples of the protrusion include a substantially columnar elastic structure. The use of such a structure as a protrusion reduces the rigidity of the protrusion and enhances the pliability of the protrusion with respect to the surface roughness of the substrate, whereby the protrusion can have a high level of adhesion force.

Another embodiment is a bonding member that has directionally dependent adhesion force as a result of varying the adhesive energy between the protrusion and the substrate.

The bonding member according to the embodiment of the invention includes a protrusion that protrudes from the surface of a base and an end face of the protrusion adheres to a substrate with the surface force between the end face and the substrate.

In this embodiment, Δγ1^{c} and Δγ2^{c} differ from each other so that G1^{c}/Δγ1^{c}≠G2^{c}/Δγ2^{c} is satisfied where G1^{c} denotes the strain-energy-release rate at a first release portion of the protrusion when a force is exerted on the protrusion in a first direction parallel to the surface, Δγ1^{c} denotes the adhesive energy at the first release portion, G2^{c} denotes the strain-energy-release rate at a second release portion of the protrusion when a force that has the same magnitude as the force exerted in the first direction is exerted on the protrusion in a second direction opposite to the first direction, and Δγ2^{c} denotes the adhesive energy at the second release portion.

As described above, the adhesion force against a force exerted in the first direction and the adhesion force against a force exerted in the second direction are obtained as F(G1^{c}/Δγ1^{c})^{-1/2} and F(G2^{c}/Δγ2^{c})^{-1/2}, respectively.

Thus, in this embodiment, when Δγ1^{c} and Δγ2^{c} differ from each other so that G1^{c}/Δγ1^{c}≠G2^{c}/Δγ2^{c} is satisfied, the adhesion force has such directional dependency that the adhesion force against a force exerted in the first direction is different from the adhesion force against a force exerted in the second direction.

The strain-energy-release rate can be estimated through a method such as structure analysis. Thus, this embodiment enables persons having ordinary skill in the art to easily design the adhesion energies Δγ1^{c} and Δγ2^{c} in such a manner that G1^{c}/Δγ1^{c}≠G2^{c}/Δγ2^{c} is satisfied.

The bonding member increases its directional dependency with increasing difference between G1^{c}/Δγ1^{c} and G2^{c}/Δγ2^{c}. For example, bonding members in which either G1^{c}/Δγ1^{c} or G2^{c}/Δγ2^{c} is at least two times as large as the other are suitable, or bonding members in which either G1^{c}/Δγ1^{c} or G2^{c}/Δγ2^{c} is at least five times as large as the other are more suitable.

The adhesion energies Δγ1^{c} and Δγ2^{c} having a large difference therebetween are suitably used. A desirable difference between the adhesion energies Δγ1^{c} and Δγ2^{c} is at least two times. A more desirable difference between the adhesion energies Δγ1^{c} and Δγ2^{c} is at least five times.

In the case where the surface force is an intermolecular interactive force, the adhesive energies Δγ1^{c} and Δγ2^{c} can be obtained by various methods such as contact angle measurement, molecular dynamics simulation, or a JKR test.

Even in the case where the surface force is an interactive force other than the intermolecular interactive force, the adhesive energies can be obtained by calculating the work required to separate bonded surfaces on which the surface force is exerted from each other to the infinity and then calculating the work per unit bonding area. The adhesive energy is a physical quantity defined as an interactive energy between the end face of the protrusion and the substrate. Thus, the adhesive energies Δγ1^{c} and Δγ2^{c} can differ from each other by changing, not only the surface state of the end face of the protrusion but also the surface state of the substrate.

The adhesion force can have directional dependency by varying the contact state between the first release portion and the second release portion as a result of varying the surface roughness. Varying the contact state in accordance with the surface roughness can be understood as providing gaps in the bonded portion in which the adhesive energy is regarded as zero.

In other words, the apparent average adhesive energy is regarded as being reduced by increasing the surface roughness. Thus, bonding members that have directionally dependent adhesion force as a result of varying the surface roughness of the end face (bottom face) of the protrusion or the substrate can be included in this embodiment.

Another embodiment is a bonding member in which G1^{c}, G2^{c}, Δγ1^{c}, and Δγ2^{c} satisfy G1^{c}<G2^{c} and Δγ1^{c}>Δγ2^{c} or G1^{c}>G2^{c} and Δγ1^{c}<Δγ2^{c}.

The reason for this is as follows.

When G1^{c}/Δγ1^{c}<G2^{c}/Δγ2^{c}, the bonding member has a higher level of adhesion force against a force exerted in the first direction, whereas when G1^{c}/Δγ1^{c}>G2^{c}/Δγ2^{c}, the bonding member has a higher level of adhesion force against a force exerted in the second direction.

Thus, when G1^{c}<G2^{c} and Δγ1^{c}>Δγ2^{c}, such directional dependency of the adhesion force that the adhesion force against a force exerted in the first direction is higher is further enhanced with the synergy between the effect of the strain energy dependent on the bulk properties of the protrusion or the substrate and the effect of the adhesive energy dependent on the surface properties.

On the other hand, when G1^{c}>G2^{c} and Δγ1^{c}<Δγ2^{c}, such directional dependency of the adhesion force that the adhesion force against a force exerted in the second direction is higher is further enhanced.

The variable range of the adhesive energy usually has an upper limit or a lower limit due to restraints such as a manufacturing process of the protrusion. In such a case, it is desirable to determine the adhesive energies at the first release portion and the second release portion in the range described as below.

In the case where G1^{c}>G2^{c}, it is most effective to determine the adhesive energy at the first release portion as the lower limit and the adhesive energy at the second release portion as the upper limit.

In the case where G1^{c}<G2^{c}, it is most effective to determine the adhesive energy at the first release portion as the upper limit and the adhesive energy at the second release portion as the lower limit.

In the case where G1^{c}=G2^{c}, it is most effective to determine the adhesive energy at either the first release portion or the second release portion as the lower limit and the adhesive energy at the other release portion as the upper limit.

In short, another embodiment is a bonding member that satisfies G1^{c}≧G2^{c} and the adhesive energy Δγ^{c} at an appropriate portion on the end face of the protrusion satisfies Δγ1^{c}≦Δγ^{c} and/or Δγ2^{c}≧Δγ^{c}.

Another embodiment is a bonding member that satisfies G1^{c}≧G2^{c} and the adhesive energy Δγ^{c} at an appropriate portion on the end face (bottom face) of the protrusion satisfies Δγ1^{c}≧Δγ^{c} and/or Δγ2^{c}≦Δγ^{c}.

Suitable examples of the protrusion include a substantially columnar elastic structure. The use of such a structure as a protrusion reduces the rigidity of the protrusion and increases the pliablity of the protrusion with respect to the surface roughness of the substrate, whereby the protrusion can have a high level of adhesion force.

Another embodiment is a bonding member in which the end face (bottom face) has two regions each having a substantially even adhesive energy and the adhesive energy in the region including the first release portion is Δγ1^{c} whereas the adhesive energy in the region including the second release portion is Δγ2^{c}.

This embodiment is advantageous in that it facilitates the manufacturing process of controlling the surface state of the end face (bottom face) of the protrusion or the substrate or facilitates the designing process for specifying the first release portion or the second release portion using a method such as structure analysis.

Examples of a method for differentiating Δγ1^{c} from Δγ2^{c} by varying the adhesive energy between the protrusion and the substrate include the following methods.

The adhesive energy can be varied by irradiating part of the protrusion made of a uniform material with electron or ion beams, ultraviolet light, or plasma while the amount of energy is being controlled so that the material properties of only part of the outermost surface of the end face (bottom face) are changed.

Alternatively, an atom or molecule layer may be additionally provided in part of the end face of the protrusion by performing various types of physical or chemical processes.

In one of the embodiments in which the modulus of elasticity and/or the Poisson's ratio is varied, the method for manufacturing a protrusion made of various types of materials has been described as an example. This method is also useful for varying the adhesive energy between the protrusion and the substrate.

Other conceivable methods for differentiating apparent Δγ1^{c} from Δγ2^{c} by varying the surface roughness between the first release portion and the second release portion include a method for processing part of the end face (bottom face) of the protrusion by light, electron beams, ion beams, machining, or other ways. Which method is most suitable for differentiating apparent Δγ1^{c} from Δγ2^{c} may be appropriately determined on the basis of, such as, specifications required for the bonding member.

The directional dependency of the adhesion force can be further enhanced by appropriately combining the process of varying the modulus of elasticity and/or the Poisson's ratio of the protrusion, the process of making the horizontal cross section of the protrusion asymmetric, and the process of varying the adhesive energy between the protrusion and the substrate.

In addition, it is known that the adhesion force can have directional dependency by making the vertical cross section of the protrusion left-right asymmetric, as in the case of an inclined column. When this process is also appropriately combined, the directional dependency of the adhesion force can be further enhanced.

Here, the strain-energy-release rate at the first release portion of the protrusion is denoted by G1, the adhesive energy at the first release portion is denoted by Δγ1, the strain-energy-release rate at the second release portion is denoted by G2, and the adhesive energy at the second release portion is denoted by Δγ2. Here, the adhesion force against a force exerted in the first direction and the adhesion force against a force exerted in the second direction are respectively calculated as F(G1/Δγ1)^{-1/2} and F(G2/Δγ2)^{-1/2}, as described above.

Here, when the level of the directional dependency of the adhesion force is expressed as R=(adhesion force against a force exerted in the second direction)/(adhesion force against a force exerted in the first direction), R=(G1Δγ2/G2Δγ1)^{1/2}.

In the range where R<1, that is, G1Δγ2/G2Δγ1<1, the adhesion force against a force exerted in the first direction is high. The directional dependency of the adhesion force increases with decreasing G1Δγ2/G2Δγ1.

On the other hand, when R>1, that is, G1Δγ2/G2Δγ1>1, the adhesion force against a force exerted in the second direction is high. The directional dependency of the adhesion force increases with increasing G1Δγ2/G2Δγ1.

Thus, the directional dependency of the adhesion force can be further enhanced by appropriately designing the bonding member so that G1Δγ2/G2Δγ1 further decreases provided that G1Δγ2/G2Δγ1<1 or so that G1Δγ2/G2Δγ1 further increases provided that G1Δγ2/G2Δγ1>1 by combining at least two of the following features: the feature of varying the modulus of elasticity and/or the Poisson's ratio; the feature of making the horizontal cross section asymmetric; the feature of varying the adhesive energy; and the feature of making the vertical cross section asymmetric.

For example, the feature of varying the modulus of elasticity and/or the Poisson's ratio and the feature of making the horizontal cross section asymmetric can be combined.

Specifically, the bonding member according to the embodiment includes a protrusion that protrudes from a surface of a base and an end face of the protrusion adheres to a substrate with a surface force between the end face and the substrate.

The protrusion has a varied modulus of elasticity and/or a varied Poisson's ratio.

In addition, the protrusion has an asymmetric cross section taken along the plane parallel to the surface.

The bonding member satisfies G1^{a,b}/Δγ1^{a,b}≠G2^{a,b}/Δγ2^{a,b}, where G1^{a,b} denotes the strain-energy-release rate at a first release portion of the protrusion when a force is exerted on the protrusion in the first direction parallel to the surface, Δγ1^{a,b} denotes the adhesive energy at the first release portion, G2^{a,b} denotes the strain-energy-release rate at a second release portion of the protrusion when a force having the same magnitude as the force exerted in the first direction is exerted on the protrusion in the second direction opposite to the first direction, and Δγ2^{a,b} denotes the adhesive energy at the second release portion.

The bonding member satisfies G^{a,b}Δγ2^{a,b}/G2^{a,b}Δγ1^{a,b}<G1^{a-,b}Δγ2^{a-,b}/G2^{a-,b}Δγ1^{a-,b}<1 or G1^{a,b}Δγ2^{a,b}/G2^{a,b}Δγ1^{a,b}>G1^{a-,b}Δγ2^{a-,b}/G2^{a-,b}Δγ1^{a-,b}>1 where, provided that the protrusion is assumed to have an even modulus of elasticity and an even Poisson's ratio, the strain-energy-release rate G1^{a,b} is denoted by G1^{a-,b}, the adhesive energy Δγ1^{a,b} is denoted by Δγ1^{a-,b}, the strain-energy-release rate G2^{a,b} is denoted by G2^{a-,b}, and the adhesive energy Δγ2^{a,b} is denoted by Δγ2^{a-,b}.

Here, the modulus of elasticity and the Poisson's ratio of the protrusion assumed to be even are average values of a varied modulus of elasticity and a varied Poisson's ratio of the protrusion. The case where the protrusion is assumed to have an even modulus of elasticity and an even Poisson's ratio is the case where the properties of the protrusion other than the modulus of elasticity and the Poisson's ratio are the same and the modulus of elasticity and the Poisson's ratio are values averaged throughout the protrusion.

When the bonding member satisfies G1^{a-,b}Δγ2^{a-,b}/G2^{a-,b}Δγ1^{a-,b}>1, the bonding member has adhesion force having a high level of directional dependency in the first direction although having an even modulus of elasticity and an even Poisson's ratio.

In addition to this characteristic, when the bonding member satisfies G1^{a,b}Δγ2^{a,b}/G2^{a,b}Δγ1^{a,b}<G1^{a-,b}Δγ2^{a-,b}/G2^{a-,b}Δγ1^{a-,b}<1 by varying the modulus of elasticity and/or the Poisson's ratio, the directional dependency of the adhesion force can be further enhanced.

Similarly, when the bonding member satisfies G1^{a-,b}Δγ2^{a-,b}/G2^{a-,b}Δγ1^{a-,b}<1, the bonding member has adhesion force having a high level of directional dependency in the second direction although having an even modulus of elasticity and an even Poisson's ratio.

In addition to this characteristic, when the bonding member satisfies G^{a,b}Δγ2^{a,b}/G2^{a,b}Δγ1^{a,b}>G1^{a-,b}Δγ2^{a-,b}/G2^{a-,b}Δγ1^{a-,b}>1 by varying the modulus of elasticity and/or the Poisson's ratio, the directional dependency of the adhesion force can be further enhanced.

Specifically, this structure can exert adhesion force with a high level of directional dependency with the synergy between the effect resulting from varying the modulus of elasticity and/or the Poisson's ratio of the protrusion and the effect resulting from making the horizontal cross section of the protrusion asymmetric.

As described above, G1^{a,b}Δγ2^{a,b}/G2^{a,b}Δγ1^{a,b} or G1^{a-,b}Δγ2^{a-,b}/G2^{a-,b}Δγ1^{a-,b} can be obtained by a combination of structure analysis or measurement through experiments. This embodiment thus enables persons having ordinary skill in the art to easily design a bonding member having the above-described feature and also bonding members having all the possible combinations of the following features.

Another example of a combination of features is to combine the feature of varying the modulus of elasticity and/or the Poisson's ratio and the feature of varying the adhesive energy.

Specifically, a bonding member according to an embodiment is a bonding member that includes a protrusion that protrudes from a surface of a base and an end face of the protrusion adheres to a substrate with a surface force between the end face and the substrate.

The protrusion has a varied modulus of elasticity and/or a varied Poisson's ratio.

Δγ1^{a,c} and Δγ2^{a,c} differ from each other and the bonding member satisfies G1^{a,b}/Δγ1^{a,b}≠G2^{a,b}/Δγ2^{a,b}, where G1^{a,c} denotes the strain-energy-release rate at a first release portion of the protrusion when a force is exerted on the protrusion in a first direction parallel to the surface, Δγ1^{a,c} denotes the adhesive energy at the first release portion, G2^{a,c} denotes the strain-energy-release rate at a second release portion of the protrusion when a force having the same magnitude as the force exerted in the first direction is exerted on the protrusion in a second direction opposite to the first direction, and Δγ2^{a,c} denotes the adhesive energy at the second release portion.

The bonding member satisfies G1^{a,c}Δγ2^{a,c}/G2^{a,c}Δγ1^{a,c}<G1^{a-,c}Δγ2^{a-,c}/G2^{a-,c}Δγ1^{a-,c}<1 or G1^{a,c}Δγ2^{a,c}/G2^{a,c}Δγ1^{a,c}>G1^{a-,c}Δγ2^{a-,c}/G2^{a-,c}Δγ1^{a-,c}>1 where, provided that the protrusion is assumed to have an even modulus of elasticity and an even Poisson's ratio, the strain-energy-release rate G1^{a,c} is denoted by G1^{a-,c}, the adhesive energy Δγ1^{a,c} is denoted by Δγ1^{a-,c}, the strain-energy-release rate G2^{a,c} is denoted by G2^{a-,c}, and the adhesive energy Δγ2^{a,c} is denoted by Δγ2^{a-,c}.

This structure can exert adhesion force with a high level of directional dependency with the synergy between the effect resulting from varying the modulus of elasticity and/or the Poisson's ratio of the protrusion and the effect resulting from varying the adhesive energy between the protrusion and the substrate.

Another example of a combination of features is to combine the feature of varying the modulus of elasticity and/or the Poisson's ratio and the feature of making the vertical cross section asymmetric. Specifically, the latter feature is to make the cross section of the protrusion taken along the plane perpendicular to the surface and parallel to the first direction left-right asymmetric.

The cross section of the protrusion taken along the plane perpendicular to the surface of the base and parallel to the first direction is also referred to as a vertical cross section.

A bonding member according to the embodiment includes a protrusion that protrudes from a surface of a base and an end face of the protrusion adheres to a substrate with a surface force between the end face and the substrate.

The protrusion has a varied modulus of elasticity and/or a varied Poisson's ratio.

In addition, the protrusion has a left-right asymmetric cross section taken along the plane perpendicular to the surface and parallel to the first direction.

The bonding member satisfies G1^{a,d}/Δγ1^{a,d}≠G2^{a,d}/Δγ2^{a,d}, where G1^{a,d} denotes the strain-energy-release rate at a first release portion of the protrusion when a force is exerted on the protrusion in the first direction parallel to the surface, Δγ1^{a,d} denotes the adhesive energy at the first release portion, G2^{a,d} denotes the strain-energy-release rate at a second release portion of the protrusion when a force having the same magnitude as the force exerted in the first direction is exerted in the second direction opposite to the first direction, and Δγ2^{a,d} denotes the adhesive energy at the second release portion.

The bonding member satisfies G1^{a,d}Δγ2^{a,d}/G2^{a,d}Δγ^{a,d}<G1^{a-,d}Δγ2^{a-,d}/G2^{a-,d}Δγ^{a-,d}<1 or G1^{a,d}Δγ2^{a,d}/G2^{a,d}Δγ1^{a,d}>G1^{a-,d}Δγ2^{a-,d}/G2^{a-,d}Δγ^{a-,d}>1 where, provided that the protrusion is assumed to have an even modulus of elasticity and an even Poisson's ratio, the strain-energy-release rate G1^{a,d} is denoted by G1^{a-,d}, the adhesive energy Δγ1^{a,d} is denoted by Δγ1^{a-,d}, the strain-energy-release rate G2^{a,d} is denoted by G2^{a-,d}, and the adhesive energy Δγ2^{a,d} is denoted by Δγ2^{a-,d}.

This structure can exert adhesion force with a high level of directional dependency with the synergy between the effect resulting from varying the modulus of elasticity and/or the Poisson's ratio of the protrusion and the effect resulting from making the vertical cross section of the protrusion asymmetric.

Another example of a combination of features is to combine the feature of making the horizontal cross section asymmetric and the feature of varying the adhesive energy.

Specifically, a bonding member according to an embodiment is a bonding member that includes a protrusion that protrudes from a surface of a base and an end face of the protrusion adheres to a substrate with a surface force between the end face and the substrate.

The protrusion has an asymmetric cross section taken along a plane parallel to the surface.

Δγ1^{b,c} and Δγ2^{b,c} differ from each other and the bonding member satisfies G1^{b,c}/Δγ1^{b,c}≠G2^{b,c}/Δγ2^{b,c}, where G1^{b,c} denotes the strain-energy-release rate at a first release portion of the protrusion when a force is exerted on the protrusion in a first direction parallel to the surface, Δγ1^{b,c} denotes the adhesive energy at the first release portion, G2^{b,c} denotes the strain-energy-release rate at a second release portion of the protrusion when a force having the same magnitude as the force exerted in the first direction is exerted on the protrusion in a second direction opposite to the first direction, and Δγ2^{b,c} denotes the adhesive energy at the second release portion.

The bonding member satisfies G1^{b,c}/Δγ1^{b,c}≠G2^{b,c}/Δγ2^{b,c}<G1^{b,c-}Δγ2^{b,c-}/G2^{b,c-}Δγ1^{b,c-}<1 or G1^{b,c}Δγ2^{b,c}/G2^{b,c}Δγ1^{b,c}>G1^{b,c-}Δγ2^{b,c-}/G2^{b,c-}Δγ1^{b,c-}>1 where, provided that Δγ1^{b,c} is assumed to be equal to Δγ2^{b,c}, the strain-energy-release rate G1^{b,c} is denoted by G1^{b,c-}, the adhesive energy Δγ1^{b,c} is denoted by Δγ1^{b,c-}, the strain-energy-release rate G2^{b,c} is denoted by G2^{b,c-}, and the adhesive energy Δγ2^{b,c} is denoted by Δγ2^{b,c-}.

Here, the case where Δγ1^{b,c} is assumed to be equal to Δγ2^{b,c} is the case where the properties of the protrusion other than the adhesive energy are the same. G1^{b,c-}Δγ2^{b,c-}/G2^{b,c-}Δγ1^{b,c-} in this case can be obtained by a combination of structure analysis or measurement through experiments.

This structure can exert adhesion force with a high level of directional dependency with the synergy between the effect resulting from making the horizontal cross section of the protrusion asymmetric and the effect resulting from varying the adhesive energy between the protrusion and the substrate.

Another example of a conceivable combination of features is to combine the feature of making the horizontal cross section asymmetric and the feature of making the vertical cross section asymmetric.

Specifically, a bonding member according to an embodiment is a bonding member that includes a protrusion that protrudes from a surface of a base and an end face of the protrusion adheres to a substrate with a surface force between the end face and the substrate.

The protrusion has an asymmetric cross section taken along a plane parallel to the surface.

The protrusion has a left-right asymmetric cross section taken along a plane perpendicular to the surface and parallel to the first direction.

The bonding member satisfies G1^{b,d}/Δγ1^{b,d}≠G2^{b,d}/Δγ2^{b,d}, where G1^{b,d} denotes the strain-energy-release rate at a first release portion of the protrusion when a force is exerted on the protrusion in a first direction parallel to the surface, Δγ1^{b,d} denotes the adhesive energy at the first release portion, G2^{b,d} denotes the strain-energy-release rate at a second release portion of the protrusion when a force having the same magnitude as the force exerted in the first direction is exerted on the protrusion in a second direction opposite to the first direction, and Δγ2^{b,d} denotes the adhesive energy at the second release portion.

The bonding member satisfies G1^{b,d}Δγ2^{b,d}/G2^{b,d}Δγ1^{b,d}<G1^{b,d-}Δγ2^{b,d-}/G2^{b,d-}Δγ1^{b,d-}<1 or G1^{b,d}Δγ2^{b,d}/G2^{b,d}Δγ1^{b,d}>G1^{b,d-}Δγ2^{b,d-}/G2^{b,d-}Δγ1^{b,d-}>1 where, provided that the protrusion is assumed to have a left-right symmetric cross section taken along a plane perpendicular to the surface and parallel to the first direction, the strain-energy-release rate G1^{b,d} is denoted by G1^{b,d-}, the adhesive energy Δγ1^{b,d} is denoted by Δγ1^{b,d-}, the strain-energy-release rate G2^{b,d} is denoted by G2^{b,d-}, and the adhesive energy Δγ2^{b,d} is denoted by Δγ2^{b,d-}.

Here, the case where the protrusion is assumed to have a left-right symmetric cross section taken along a plane perpendicular to the surface and parallel to the first direction is the following case. Firstly, the protrusion is regarded as a stack of thin slices infinitely sliced in the direction parallel to the surface. These slices are shifted parallel to the surface and stacked one on top of another again in such a manner that the cross section of the protrusion taken along the plane perpendicular to the surface and parallel to the first direction is left-right symmetric. An imaginary protrusion thus obtained is defined as the protrusion assumed to have a left-right symmetric cross section.

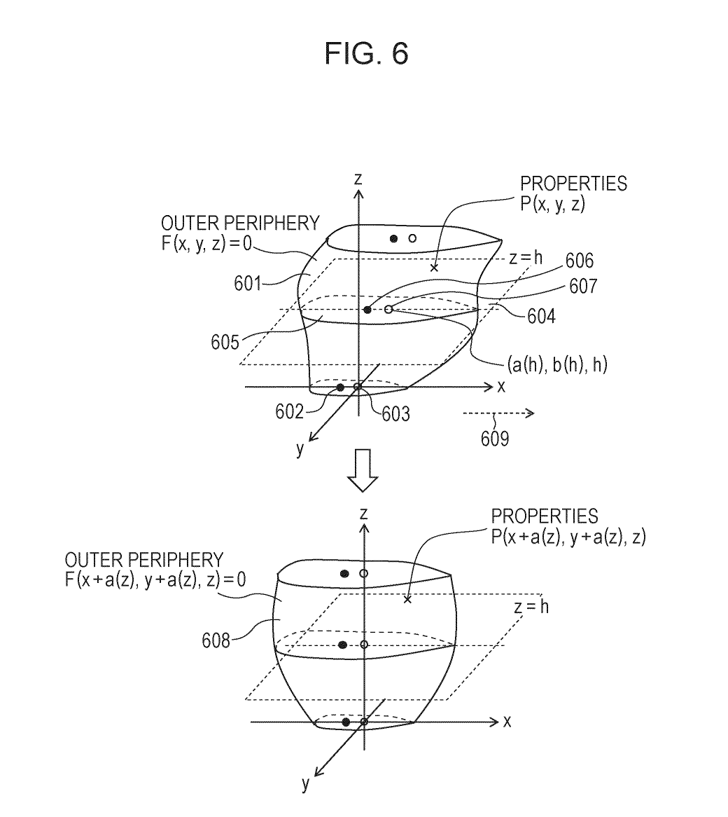

Referring to FIG. 6, more specific procedure is described. A straight line that passes through the centroid 602 of the end face of the protrusion 601 and that is parallel to the first direction 609 is drawn and the middle point 603 between two intersection points at which the straight line intersects the outer periphery of the end face of the protrusion is taken.

By using this middle point as the origin, the x axis extending in the first direction, the z axis extending in the direction perpendicular to the surface of the base, and the y axis extending in the direction perpendicular to the x axis and the z axis are provided. Thus, the periphery of the protrusion can be expressed by the equation F(x, y, z)=0. Moreover, the vector quantity in the coordinates (x, y, z) representing various properties of the protrusion can be expressed by P(x, y, z).

Subsequently, a straight line that passes through the centroid 606 of the cross section 605 of the protrusion, taken along a plane 604 defined by z=h, and that is parallel to the first direction is drawn. The coordinates of the middle point 607 between two intersection points at which the straight line and the outer periphery of the cross section intersect are defined as (a(h), b(h), h). Each cross section is shifted in a direction parallel to the xy plane so that the middle point thus obtained is positioned on the z axis to form an imaginary protrusion 608. This imaginary protrusion has a left-right symmetric cross section taken along the plane perpendicular to the surface of the base and parallel to the first direction.

Thus, the outer periphery of the imaginary protrusion assumed to have a left-right symmetric cross section can be defined by the equation F(x+a(z), y+b(z), z)=0.

In addition, by defining the vector quantity representing various properties of the imaginary protrusion in the coordinates (x, y, z) as P(x+a(z), y+b(z), z), the distribution of the properties can be maintained. When such an imaginary protrusion defined as above is used, G1^{b,d-}Δγ2^{b,d-}/G2^{b,d-}Δγ1^{b,d-} can be obtained by a combination of structure analysis or measurement through experiments.

This structure can exert adhesion force with a high level of directional dependency with the synergy between the effect resulting from making the horizontal cross section of the protrusion asymmetric and the effect resulting from making the vertical cross section of the protrusion asymmetric.

Another example of a conceivable combination of features is to combine the feature of varying the adhesive energy and the feature of making the vertical cross section asymmetric.

Specifically, a bonding member according to an embodiment is a bonding member that includes a protrusion that protrudes from a surface of a base and an end face of the protrusion adheres to a substrate with a surface force between the end face and the substrate.

The protrusion has a left-right asymmetric cross section taken along a plane perpendicular to the surface and parallel to the first direction.

Δγ1^{c,d} and Δγ2^{c,d} differ from each other and the bonding member satisfies G1^{c,d}/Δγ1^{c,d}≠G2^{c,d}/Δγ2^{c,d}, where G1^{c,d} denotes the strain-energy-release rate at a first release portion of the protrusion when a force is exerted on the protrusion in a first direction parallel to the surface, Δγ1^{c,d} denotes the adhesive energy at the first release portion, G2^{c,d} denotes the strain-energy-release rate at a second release portion of the protrusion when a force having the same magnitude as the force exerted in the first direction is exerted on the protrusion in a second direction opposite to the first direction, and Δγ2^{c,d} denotes the adhesive energy at the second release portion.

The bonding member satisfies G^{c,d}Δγ2^{c,d}/G2^{c,d}Δγ1^{c,d}<G1^{c-,d}Δγ2^{c-,d}/G2^{c-,d}Δγ1^{c-,d}<1 or G1^{c,d}Δγ2^{c,d}/G2^{c,d}Δγ1^{c,d}>G1^{c-,d}Δγ2^{c-,d}/G2^{c-,d}Δγ1^{c-,d}>1 where, when Δγ1^{c,d} is assumed to be equal to Δγ2^{c,d}, the strain-energy-release rate G1^{c,d} is denoted by G1^{c,d}, the adhesive energy Δγ1^{c,d} is denoted by Δγ1^{c,d}, the strain-energy-release rate G2^{c,d} is denoted by G2^{c,d}, and the adhesive energy Δγ2^{c,d} is denoted by Δγ2^{c,d}.

This structure can exert adhesion force with a high level of directional dependency with the synergy between the effect resulting from varying the adhesive energy between the protrusion and the substrate and the effect resulting from making the vertical cross section of the protrusion asymmetric.

Another example of a combination of features is to combine three or more features among the feature of varying the modulus of elasticity and/or the Poisson's ratio, the feature of making the horizontal cross section asymmetric, the feature of varying the adhesive energy, and the feature of making the vertical cross section asymmetric. When a bonding member is formed so as to have a combination of three or more features, the directional dependency of the adhesion force can be further enhanced by appropriately combining any of the features so that G1Δγ2/G2Δγ1 is further reduced provided that G1Δγ2/G2Δγ1<1 or G1Δγ2/G2Δγ1 is further increased provided that G1Δγ2/G2Δγ1>1.

Hereinbelow, the present invention is described further in detail with specific embodiments and reference examples.

### Example 1

Before an example of the structure of a bonding member is described, an example of a method for calculating the strain-energy-release rate through simulation and an example of a method for calculating the adhesion profile through simulation are described.

Calculation of Strain-Energy-Release Rate through Simulation

For example, the strain-energy-release rate at a release portion of a protrusion (elastic structure) can be obtained by a method similar to the virtual crack extension method in the fracture mechanics (hereinafter this method is referred to as a virtual release extension method).

The surface force and the relative displacement at the virtual release portion used in the virtual release extension method are obtained by, for example, structure analysis based on the boundary element method. A boundary integral equation obtained from the Somigliana is used as an integral equation, and a Rongved's solution, which is a fundamental solution of two-phase materials, is used as a fundamental solution. The use of this fundamental solution eliminates the need for providing a nodal point at the junction between the protrusion and the substrate at which a complex stress occurs, and thus enables more highly accurate calculation.

Here, for ease of illustration, the protrusion is assumed to have such a shape as to be symmetric in the direction that is parallel to the surface of a base from which the protrusion protrudes and that is perpendicular to the first direction. In this case, the behavior of a structure can be analyzed within a two-dimensional plane defined by the first direction and the direction perpendicular to the surface. The method described below is naturally and easily expandable to three dimensions.

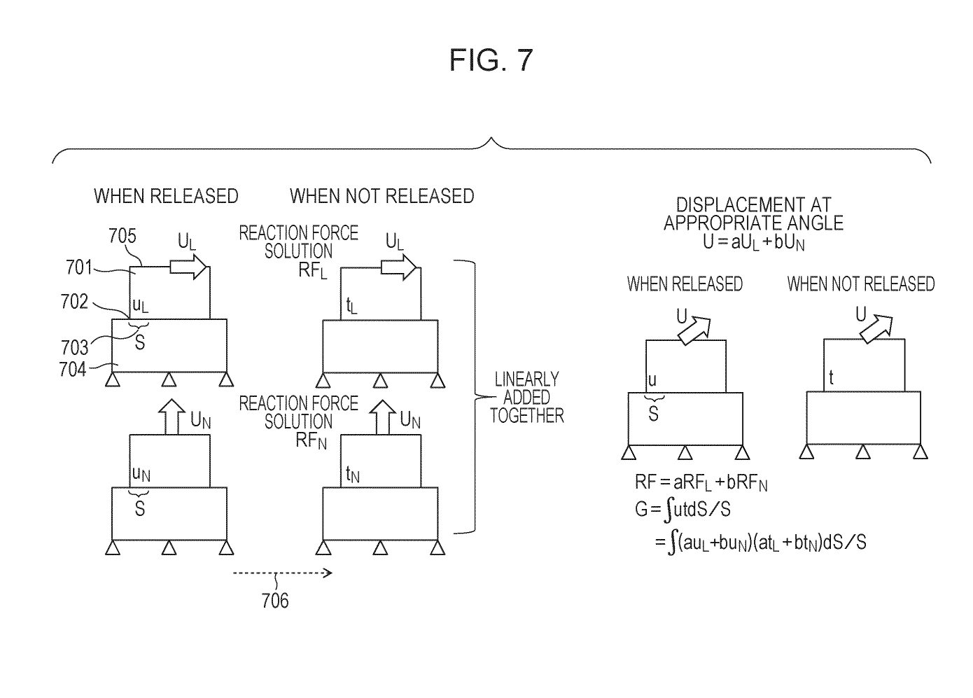

In order to calculate the strain-energy-release rate at a first release portion of the protrusion (elastic structure) when a force is exerted on the protrusion in the first direction, a minute virtual release portion 703 is defined at a first release portion 702 of the elastic structure 701 as illustrated in FIG. 7.

Firstly, structure analysis is performed in the state where the protrusion end face (bottom face) other than the virtual release portion adheres to the substrate 704 (in the release state) and a displacement vector U_{L} in the first direction 706 or the displacement vector U_{N} in the direction perpendicular to the surface of the base is provided to the nodal point of the structure top surface 705.

This structure analysis calculates relative displacement vectors u_{L} and u_{N} between the structure bottom surface and the substrate surface that are caused at the virtual release portion by the displacement vector U_{L} and the displacement vector U_{N}.

Subsequently, structure analysis is performed in the state where the entire bottom face of the structure including the virtual release portion adheres to the substrate 704 (in the non-release state) and the displacement vector U_{L} or the displacement vector U_{N} is provided to the nodal point of the structure top surface 705. In this structure analysis, surface force vectors t_{L} and t_{N} that are respectively caused by the displacement vector U_{L} and the displacement vector U_{N} on the virtual release portion surface of the structure and reaction force vectors RF_{L} and RF_{N} caused on the structure top surface are obtained.

Solutions in the case where the displacement vector U=aU_{L}+bU_{N} in an appropriate direction in the two-dimensional plane is provided to the structure top surface are obtained by linearly adding the following results. Thus, the surface force vector t that is caused on the virtual release portion surface of the structure, the relative displacement vector u between the structure bottom surface and the substrate surface, and the reaction force vector RF that occurs on the structure top surface are as follows:

t=at_{L}+bt_{N},

u=au_{L}+bu_{N}, and

RF=aRF_{L}+bRF_{N}.

The strain-energy-release rate G at the first release portion against the reaction force vector RF thus obtained can be obtained as a function involving a and b, as described below, by dividing, by an area S of the virtual release portion, a value obtained by integrating an inner product of the surface force vector t of the virtual release portion surface and the relative displacement vector u throughout the entire virtual release portion:

G=∫(au_{L}+bu_{N})(at_{L}+bt_{N})dS/S.

The strain-energy-release rate G1 against a force having a magnitude F in the first direction is obtained by calculating a and b with which the component of the reaction force vector RF in the first direction is calculated as F and the component of the reaction force vecor RF in the direction perpendicular to the surface of the base is calculated as zero and by substituting a and b into the above expression. The strain-energy-release rate G2 at the second release portion of the structure against a force in the second direction can be similarly calculated by defining a virtual release portion in the second release portion.

A suitable example of the structure analysis is a domain decomposition method. The domain decomposition method is a calculation method involving division of the entire model that is subjected to structure analysis into multiple segments and formation of the boundary integral equation for each segment.

The boundary integral equation is calculated such that, in the case where boundary portions between segments are not separated, a constraint that causes the displacement solutions at the portions to be equal to each other is provided whereas, in the case where boundary portions between segments are separated, no constraint is provided to the portions and the boundary integral equation is calculated regarding the portions as free surfaces.

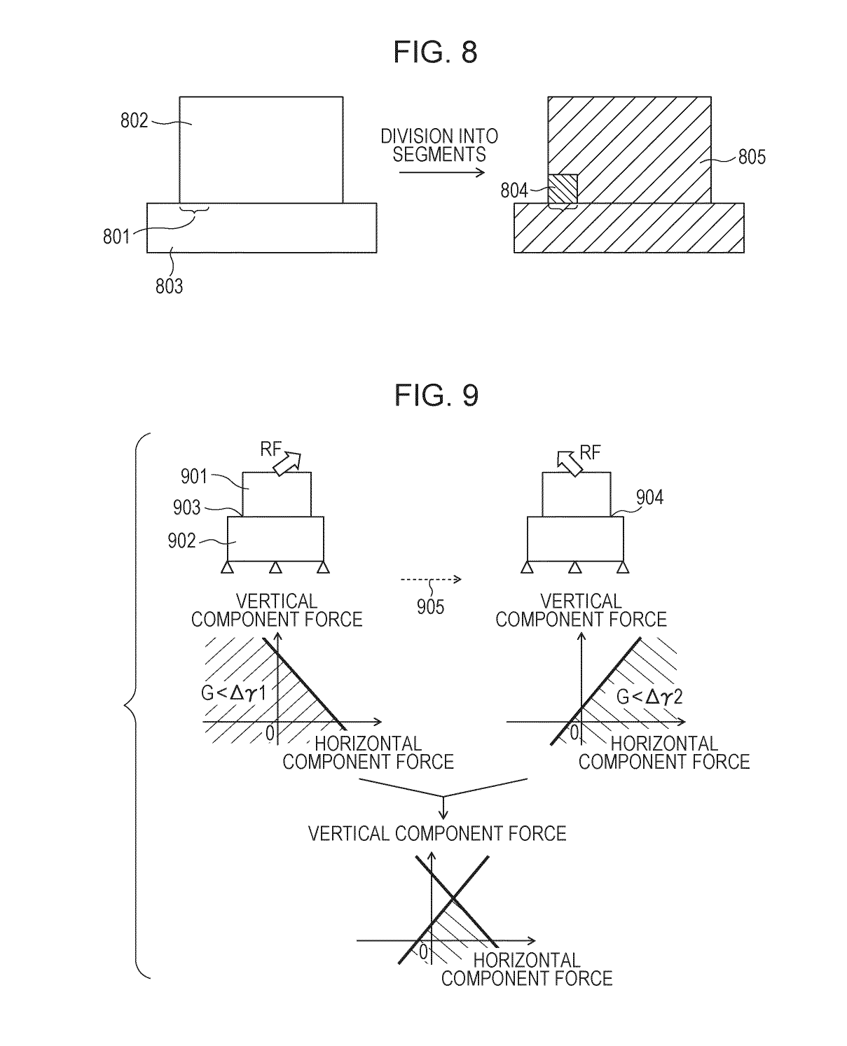

In order to calculate the strain-energy-release rate, as illustrated in FIG. 8, the structure is divided into two segments 804 and 805 or more segments in such a manner that the surface of the elastic structure 802 at the virtual release portion 801 belongs to a region different from the region to which the surface of the substrate 803 at the virtual release portion 801 belongs.

The reason why the structure is divided into segments in this manner is to eliminate a possibility that a node-to-node distance between the elastic structure surface and the substrate surface is zero and that the boundary integral equation cannot be solved.

Here, a fundamental solution of two-phase materials is used as a fundamental solution of the boundary integral equation. Thus, a region that extends over the structure and the substrate having different properties can be defined.

### Calculation of Adhesion Profile Through Simulation

FIG. 9 illustrates the method for calculating the adhesion profile.

Firstly, as in the above-described manner, the strain-energy-release rate G at the first release portion 903 when a force expressed by a vector RF is exerted on the protrusion (elastic structure) 901 is calculated. In addition, the adhesive energy Δγ1 at the first release portion is obtained by methods such as an experimental method or a molecular dynamics simulation.

When G<Δγ1, the protrusion does not start being released from the first release portion. Thus, this inequality is solved to obtain a condition that a and b have to satisfy so that the protrusion and the substrate keep being attached together.

When this condition is substituted in RF=aRF_{L}+bRF_{N}, the range of the magnitude or the angle of the force vector that does not cause the protrusion to start being released from the first release portion can be obtained. Similarly, the range of the magnitude or the angle of the force vector that does not cause the protrusion to start being released from the second release portion 904 is also obtained.

Finally, the adhesion profile can be obtained by plotting overlapping portions of both ranges of the magnitude or the angle of the force vectors on the two-dimensional coordinates in which the horizontal component parallel to the surface of the base and the vertical component perpendicular to the surface of the base are used as axes.

### Reference Example 1

In the examples and reference examples described below, the level of the directional dependency of the adhesion force or the adhesion profile of a single protrusion (elastic structure) is described.

The adhesion property of the bonding member including multiple elastic structures is expressed by the sum total of the adhesion properties of the individual elastic structures. Thus, a bonding member as a whole has directionally dependent adhesion force equivalent to that described in these examples and reference examples.

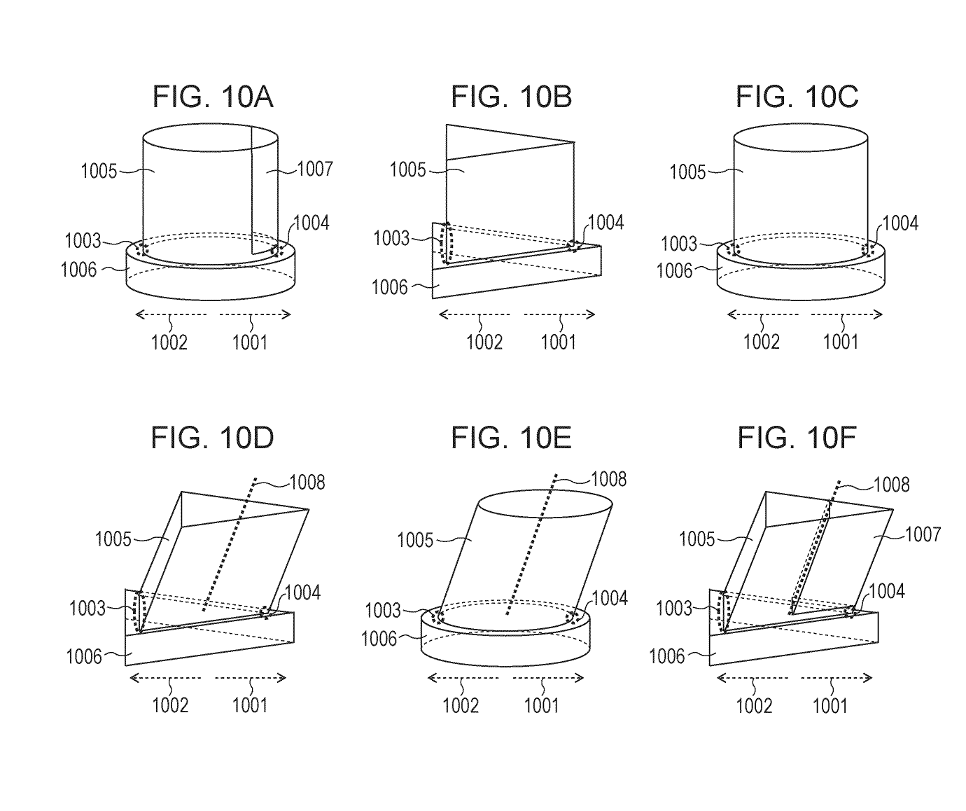

In the following examples and reference examples, the release portion was estimated by performing a rough stress analysis before performing a specific adhesion force analysis. In either example, a first release portion 1003 may be regarded as an end of the bottom face of an elastic structure 1005 in a second direction 1002 and a second release portion 1004 may be regarded as an end of the bottom face of the elastic structure 1005 in a first direction 1001 (FIGS. 10A to 10F).

### Analysis on Adhesion Profile of Protrusion Having Varied Modulus of Elasticity

FIG. 10A illustrates the shape of an analytic model.

The shape of a protrusion (elastic structure) 1005 disposed on the surface of the bonding member was defined as a cylindrical shape having a diameter of 10 μm and a height of 10 μm.

The modulus of elasticity and the Poisson's ratio in a region 1007 located at the height from the bottom face in the range of 100 nm or higher and having a width of 2 μm from the outermost portion in the first direction 1001 were respectively determined as 29 MPa and 0.45.

The modulus of elasticity and the Poisson's ratio in the remaining region were respectively determined as 0.29 MPa and 0.45. The modulus of elasticity and the Poisson's ratio of the substrate were respectively determined as 80 GPa and 0.21. The shape of the substrate 1006 for the structure analysis was determined as a cylindrical shape having a diameter of 11 μm and a height of 1 μm. The adhesive energy between the elastic structure and the substrate was determined to be uniform throughout the entire bottom face.

The strain-energy-release rate G1^{a} at the first release portion 1003 when a force of 1 μN was exerted on the elastic structure in the first direction was 3.0 mJ/m² whereas the strain-energy-release rate G2^{a} at the second release portion 1004 when a force of 1 μN was exerted on the elastic structure in the second direction 1002 was 49 mJ/m².

Here, G1^{a}/Δγ1^{a}=0.042 and G2^{a}/Δγ2^{a}=0.69 when the adhesive energies Δγ1^{a} and Δγ2^{a} at the first release portion and the second release portion are 70 mJ/m². Thus, G1^{a}/Δγ1^{a}≠G2^{a}/Δγ2^{a} is satisfied.

The adhesion force against a force exerted in the first direction is 1×(G1^{a}/Δγ1^{a})^{-1/2}=4.9 μN and the adhesion force against a force exerted in the second direction is 1×(G2^{a}/Δγ2^{a})^{-1/2}=1.2 μN. Thus, the adhesion force has directional dependency. In this case, the adhesion force against a force exerted in the first direction is stronger than the adhesion force against a force exerted in the second direction.

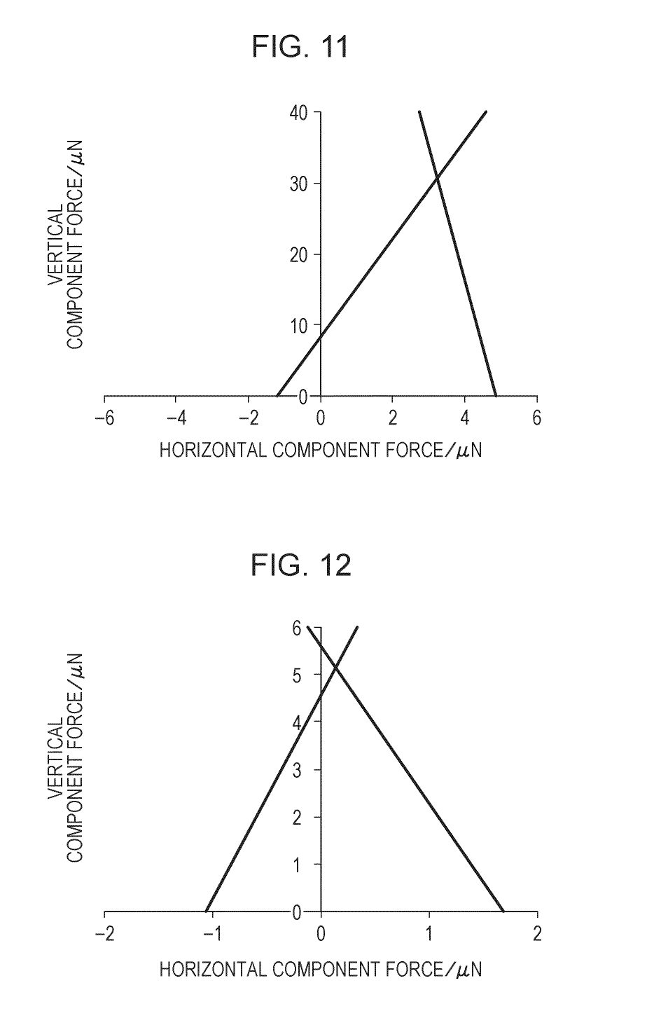

FIG. 11 shows the adhesion profile of this elastic structure.

Thus, in this example, the bonding member has adhesion force having directional dependency with the effect resulting from varying the modulus of elasticity of the protrusion.

### Reference Example 2

### Analysis on Adhesion Profile of Protrusion Having Asymmetric Horizontal Cross Section

FIG. 10B illustrates the shape of an analytic model.

The shape of a protrusion (elastic structure) 1005 disposed on the surface of the bonding member was defined as a triangular prism having a height of 10 μm and having a horizontal cross section shaped in an isosceles triangle having a base of 10 μm and a height of 10 μm. The modulus of elasticity and the Poisson's ratio were respectively determined as 0.29 MPa and 0.45.

The modulus of elasticity and the Poisson's ratio of the substrate were respectively determined as 80 GPa and 0.21. The shape of the substrate 1006 for structure analysis was defined as a triangular prism having a height of 2 μm and having a cross section shaped in an isosceles triangle having a base of 11 μm and a height of 11 μm.

Here, the first direction 1001 is defined as a direction perpendicular to the base of the cross section and extending from the base to the vertex of the isosceles triangle. The adhesive energy between the elastic structure and the substrate was made uniform throughout the entire bottom face.

The strain-energy-release rate G1^{b} at the first release portion 1003 when a force of 1 μN was exerted on the elastic structure in the first direction was 25 mJ/m² whereas the strain-energy-release rate G2^{b} at the second release portion 1004 when a force of 1 μN was exerted on the elastic structure in the second direction 1002 was 62 mJ/m².

Here, G1^{b}/Δγ1^{b}=0.36 and G2^{b}/Δγ2^{b}=0.89 when the adhesive energies Δγ1^{a} and Δγ2^{a} at the first release portion and the second release portion are 70 mJ/m². Thus, G1^{b}/Δγ1^{b}≠G2^{b}/Δγ2^{b} is satisfied.

The adhesion force against a force exerted in the first direction is 1×(G1^{b}/Δγ1^{b})^{-1/2}=1.7 μN and the adhesion force against a force exerted in the second direction is 1×(G2^{b}/Δγ2^{b})^{-1/2}=1.1 μN. Thus, the adhesion force has directional dependency. In this case, the adhesion force against a force exerted in the first direction is stronger than the adhesion force against a force exerted in the second direction.

FIG. 12 shows the adhesion profile of this elastic structure.

Thus, in this example, the bonding member has adhesion force having directional dependency with the effect resulting from making the horizontal cross section of the protrusion asymmetric.

### Example 2

### Analysis on Adhesion Profile of Protrusion Having Varied Adhesive Energy

FIG. 10C illustrates the shape of an analytic model.

The shape of a protrusion (elastic structure) 1005 disposed on the surface of the bonding member was defined as a cylindrical shape having a diameter of 10 μm and a height of 10 μm. The modulus of elasticity and the Poisson's ratio were respectively determined as 0.29 MPa and 0.45.

The modulus of elasticity and the Poisson's ratio of the substrate were respectively determined as 80 GPa and 0.21. The shape of the substrate 1006 for the structure analysis was determined as a cylindrical shape having a diameter of 11 μm and a height of 2 μm.

The adhesive energy between the elastic structure and the substrate was determined such that the adhesive energy on a first-direction half of the bottom face is 7 mJ/m² whereas the adhesive energy on a second-direction half of the bottom face is 70 mJ/m².

Thus, the adhesive energy Δγ1^{c} at the first release portion 1003 is 70 mJ/m² whereas the adhesive energy Δγ2^{c} at the second release portion 1004 is 7 mJ/m², whereby the adhesive energies Δγ1^{c} and Δγ2^{c} differ from each other.

The shape and the properties of the elastic structure are rotationally symmetric. Thus, the strain-energy-release rate at the first release portion and the strain-energy-release rate at the second release portion are the same.

Here, the strain-energy-release rates G1^{c} and G2^{c} when a force of 1 μN was exerted on the elastic structure in the first direction or the second direction were 11 mJ/m². Thus, G1^{c}/Δγ1^{c}=0.16 and G2^{c}/Δγ2^{c}=1.6, whereby G1^{c}/Δγ1^{c}≠G2^{c}/Δγ2^{c} is satisfied.

The adhesion force against a force exerted in the first direction is 1×(G1^{c}/Δγ1^{c})^{-1/2}=2.5 μN and the adhesion force against a force exerted in the second direction is 1×(G2^{c}/Δγ2^{c})^{-1/2}=0.80 μN. Thus, the adhesion force has directional dependency. In this case, the adhesion force against a force exerted in the first direction is stronger than the adhesion force against a force exerted in the second direction.

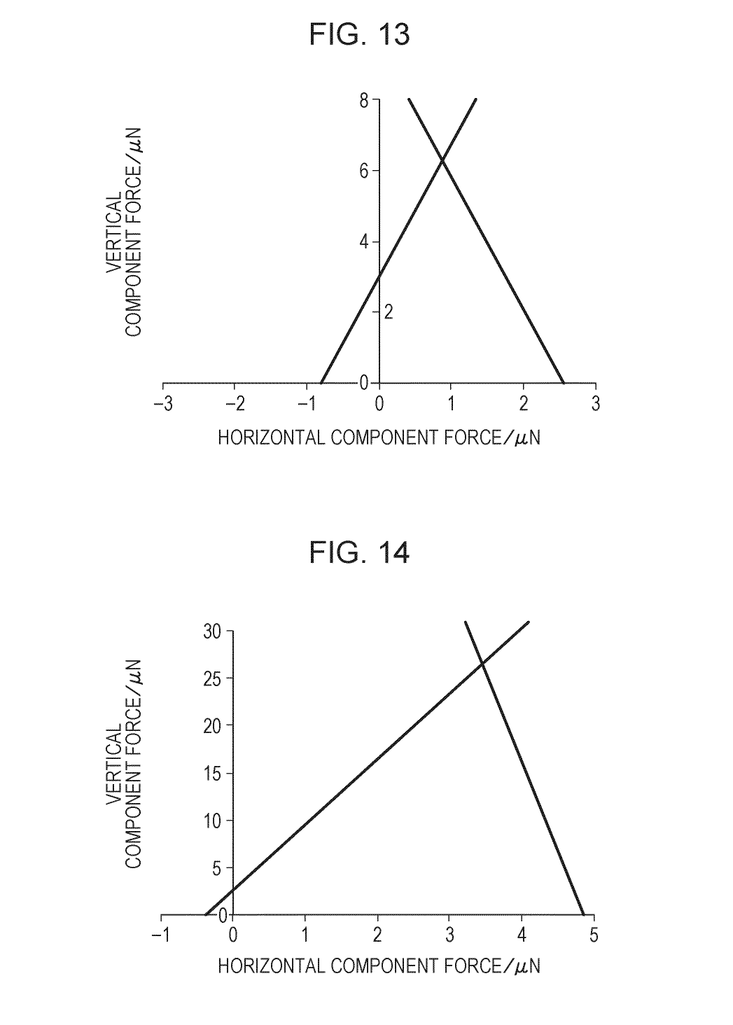

FIG. 13 shows the adhesion profile of this elastic structure.

Thus, in this example, the bonding member has adhesion force having directional dependency with the effect resulting from varying the adhesive energy between the protrusion and the substrate.

### Example 3

### Analysis on Adhesion Profile of Protrusion Having Varied Modulus of Elasticity and Varied Adhesive Energy

The shape of an analytic model used in this example was the same as that of the analytic model used in Reference Example 1 (FIG. 10A).

The adhesive energy between the protrusion (elastic structure) 1005 and the substrate 1006 was defined as 7 mJ/m² on a first-direction half of the bottom face and as 70 mJ/m² on a second-direction half of the bottom face.

Thus, the adhesive energies Δγ1^{a,c} and Δγ2^{a,c} at the first release portion 1003 and the second release portion 1004 are determined as 70 mJ/m² and 7 mJ/m², respectively, and differ from each other.

Similarly to Reference Example 1, the strain-energy-release rate G1^{a,c} at the first release portion when a force of 1 μN is exerted on the protrusion in the first direction is 3.0 mJ/m² whereas the strain-energy-release rate G2^{a,c} at the second release portion when a force of 1 μN is exerted on the protrusion in the second direction is 49 mJ/m².

Thus, G1^{a,c}/Δγ1^{a,c}=0.042, G2^{a,c}/Δγ2^{a,c}=6.9, and G1^{a,c}Δγ2^{a,c}/G2^{a,c}Δγ1^{a,c}=0.0061, whereby G1^{a,c}Δγ2^{a,c}/G2^{a,c}Δγ1^{a,c}≠1 is satisfied.

When the elastic structure is assumed to have an even modulus of elasticity and an even Poisson's ratio, the elastic structure is rotationally symmetric in both shape and properties, whereby G1^{a-,c}=G2^{a-,c}.

Since Δγ1^{a-,c}=Δγ1^{a,c}=70 mJ/m² and Δγ2^{a-,c}=Δγ2^{a,c}=7 mJ/m², G1^{a-,c}Δγ2^{a-,c}/G2^{a-,c}Δγ1^{a-,c}=0.1, whereby G1^{a,c}Δγ2^{a,c}/G2^{a,c}Δγ1^{a,c}<G1^{a-,c}Δγ2^{a-,c}/G2^{a-,c}Δγ1^{a-,c}<1 is satisfied.

Here, the adhesion force against a force exerted in the first direction is 1×(G1^{a,c}/Δγ1^{a,c})^{-1/2}=4.9 μN and the adhesion force against a force exerted in the second direction is 1×(G2^{a,c}/Δγ2^{a,c})^{-1/2}=0.38 μN. Thus, the adhesion force has directional dependency. In this case, the adhesion force against a force exerted in the first direction is stronger than the adhesion force against a force exerted in the second direction.

FIG. 14 shows the adhesion profile of the elastic structure.

Here, the level of the directional dependency of the adhesion force is expressed by R=(the adhesion force against a force exerted in the second direction)/(the adhesion force against a force exerted in the first direction). In the case where the adhesion force against a force exerted in the first direction is stronger, the directional dependency of the adhesion force increases with decreasing level of the directional dependency R. Conversely, in the case where the adhesion force against a force exerted in the second direction is stronger, the directional dependency of the adhesion force increases with increasing level of the directional dependency R.

In the case of the elastic structure according to this example, R=0.078, that is, the level of directional dependency is high. On the other hand, in the case where the elastic structure is assumed to have an even modulus of elasticity and an even Poisson's ratio, R={1×(G2^{a-,c}/Δγ2^{a-,c})−^{1/2}}/{1×(G1^{a-,c}/Δγ1^{a-,c})^{-1/2}}=0.32. Specifically, varying the modulus of elasticity and varying the adhesive energy effectively enhance the directional dependency of the adhesion force.

Thus, in this example, the bonding member has adhesion force with a very high level of directional dependency with the synergy between the effect resulting from varying the modulus of elasticity of the protrusion and the effect resulting from varying the adhesive energy at various portions of the protrusion.

### Example 4

### Analysis on Adhesion Profile of Protrusion Having Asymmetric Horizontal Cross Section and Varied Adhesive Energy

The shape of an analytic model used in this example was the same as that of the analytic model used in Reference Example 2 (FIG. 10B).

The adhesive energy between the protrusion (elastic structure) 1005 and the substrate 1006 was defined as 7 mJ/m² on a first-direction half of the bottom face and as 70 mJ/m² on a second-direction half of the bottom face.

Thus, the adhesive energies Δγ1^{b,c} and Δγ2^{b,c} at the first release portion 1003 and the second release portion 1004 are determined as 70 mJ/m² and 7 mJ/m², respectively, and differ from each other.

Similarly to Reference Example 2, the strain-energy-release rate G1^{b,c} at the first release portion when a force of 1 μN is exerted on the protrusion in the first direction is 25 mJ/m² whereas the strain-energy-release rate G2^{b,c} at the second release portion when a force of 1 μN is exerted on the protrusion in the second direction is 62 mJ/m².

Thus, G1^{b,c}/Δγ1^{b,c}=0.36, G2^{b,c}/Δγ2^{b,c}=8.9, and G1^{b,c}Δγ2^{b,c}/G2^{b,c}Δγ1^{b,c}=0.040, whereby G1^{b,c}Δγ2^{b,c}/G2^{b,c}Δγ1^{b,c}≠1 is satisfied.

When the adhesive energy at the first release portion is assumed to be equal to the adhesive energy at the second release portion, Δγ1^{b,c-}=Δγ2^{b,c-}. Since G1^{b,c-}=G1^{b,c}=25 mJ/m² and G2^{b,c-}=G2^{b,c}=62 mJ/m², G1^{b,c-}Δγ2^{b,c-}/G2^{b,c-}Δγ1^{b,c-}=0.40, whereby G1^{b,c}Δγ2^{b,c}/G2^{b,c}Δγ1^{b,c}<G1^{b,c-}Δγ2^{b,c-}/G2^{b,c-}Δγ1^{b,c-}<1 is satisfied.

The adhesion force against a force exerted in the first direction is 1×(G1^{b,c}/Δγ1^{b,c})^{-1/2}=1.7 μN and the adhesion force against a force exerted in the second direction is 1×(G2^{b,c}/Δγ2^{b,c})^{-1/2}=0.34 μN. Thus, the adhesion force has directional dependency. In this case, the adhesion force against a force exerted in the first direction is stronger than the adhesion force against a force exerted in the second direction.

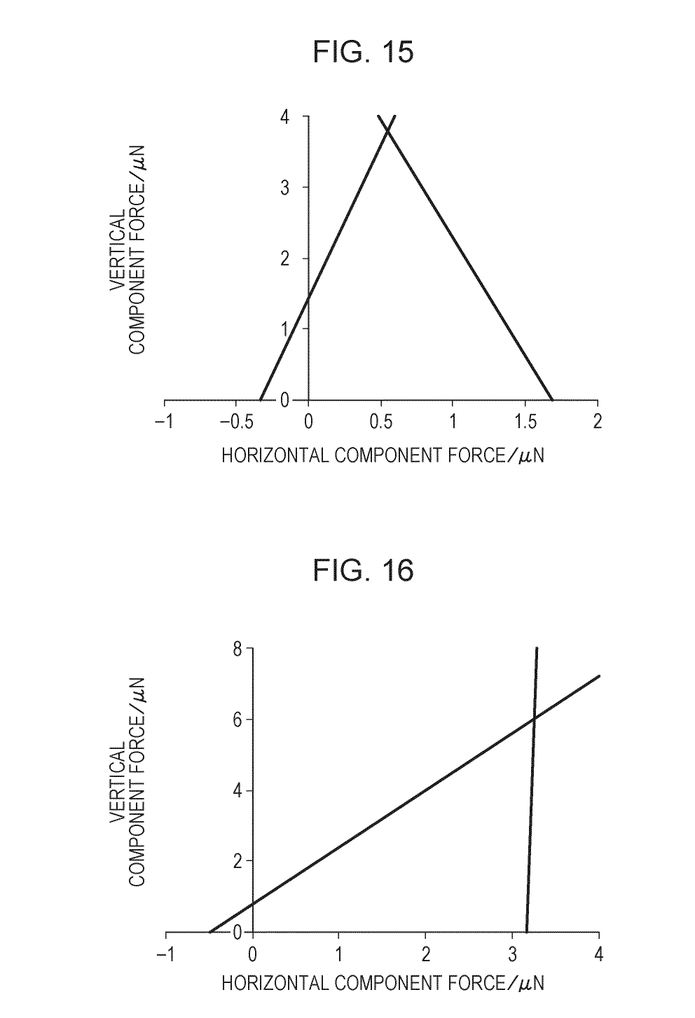

FIG. 15 shows the adhesion profile of the elastic structure.

Here, the level of the directional dependency of the adhesion force in this example is expressed by R=0.20, that is, the level of directional dependency is high. In the case where the adhesive energy at the first release portion is assumed to be equal to the adhesive energy at the second release portion, R={1×(G2^{b,c-}/Δγ2^{b,c-})^{-1/2}}/{1×(G1^{b,c-}/Δγ1^{b,c-})^{-1/2}}=0.63. Specifically, making the horizontal cross section asymmetric and varying the adhesive energy effectively enhance the directional dependency of the adhesion force.

Thus, in this example, the bonding member has adhesion force with a very high level of directional dependency with the synergy between the effect resulting from making the horizontal cross section of the protrusion asymmetric and the effect resulting from varying the adhesive energy between the protrusion and the substrate.

### Reference Example 3

### Analysis on Adhesion Profile of Protrusion Having Asymmetric Horizontal Cross Section and Asymmetric Vertical Cross Section

FIG. 10D illustrates the shape of an analytic model.

The shape of a protrusion (elastic structure) 1005 disposed on the surface of the bonding member was defined as an inclined triangular prism having a height of 10 μm and an angle formed between the axis 1008 and the first direction 1001 was determined as 60 degrees.

The protrusion has a horizontal cross section shaped in an isosceles triangle having a base of 10 μm and a height of 10 μm. In the cross section, the base of the isosceles triangle is perpendicular to the first direction and the vertex of the isosceles triangle is directed in the first direction 1001. The vertical cross section of the elastic structure has a parallelogrammatic shape and is left-right asymmetric.

The modulus of elasticity and the Poisson's ratio of the elastic structure were respectively defined as 0.29 MPa and 0.45. The modulus of elasticity and the Poisson's ratio of the substrate were respectively defined as 80 GPa and 0.21. The substrate 1006 for the structure analysis was shaped in a triangular prism having a height of 2 μm and having a cross section shaped in an isosceles triangle having a base of 11 μm and a height of 11 μm. The adhesive energy between the elastic structure and the substrate was made uniform throughout the entire bottom face.

The strain-energy-release rate G1^{b,d} at the first release portion 1003 when a force of 1 μN was exerted on the elastic structure in the first direction was 7.0 mJ/m² whereas the strain-energy-release rate G2^{b,d} at the second release portion 1004 when a force of 1 μN was exerted on the elastic structure in the second direction 1002 was 290 mJ/m². Here, G1^{b,d}/Δγ1^{b,d}=0.10 and G2^{b,d}/Δγ2^{b,d}=4.1 in the case where the adhesive energies Δγ1^{b,d} and Δγ2^{b,d} at the first release portion and at the second release portion are 70 mJ/m².

Here, G1^{b,d}Δγ2^{b,d}/G2^{b,d}Δγ1^{b,d}=0.024, whereby G1^{b,d}Δγ2^{b,d}/G2^{b,d}Δγ1^{b,d}≠1 is satisfied.

In the case where the vertical cross section parallel to the first direction of the structure is assumed to have a left-right symmetric shape, G1^{b,d-}=25 mJ/m² and G2^{b,d-}=62 mJ/m² from Reference Example 2.

Here, Δγ1^{b,d-}=Δγ1^{b,d}=Δγ2^{b,d-}=Δγ2^{b,d}=70 mJ/m², whereby G1^{b,d-}Δγ2^{b,d-}/G2^{b,d-}Δγ1^{b,d-}=0.40. Thus, G1^{b,d}Δγ2^{b,d}/G2^{b,d}Δγ1^{b,d}<G1^{b,d-}Δγ2^{b,d-}/G2^{b,d-}Δγ1^{b,d-}<1 is satisfied.

The adhesion force against a force exerted in the first direction is 1×(G1^{b,d}/Δγ1^{b,d})^{-1/2}=3.2 μN and the adhesion force against a force exerted in the second direction is 1×(G2^{b,d}/Δγ2^{b,d})^{-1/2}=0.49 μN. Thus, the adhesion force has directional dependency. In this case, the adhesion force against a force exerted in the first direction is stronger than the adhesion force against a force exerted in the second direction.

FIG. 16 shows the adhesion profile of this elastic structure.

Here, the level of the directional dependency of the adhesion force in this example is expressed by R=0.15, that is, the level of directional dependency is high. In the case where the vertical cross section parallel to the first direction of the structure is assumed to have a left-right symmetric shape, R={1×(G2^{b,d-}/Δγ2^{b,d-})^{-1/2}}/{1×(G1^{b,d-}/Δγ1^{b,d-})^{-1/2}}=0.63. Specifically, making the horizontal cross section asymmetric and making the vertical cross section asymmetric effectively enhance the directional dependency of the adhesion force.

Thus, in this example, the bonding member has adhesion force with a very high level of directional dependency with the synergy between the effect resulting from making the horizontal cross section of the protrusion asymmetric and the effect resulting from making the vertical cross section of the protrusion asymmetric.

### Example 5

### Analysis on Adhesion Profile of Protrusion Having Varied Adhesive Energy and Asymmetric Vertical Cross Section

FIG. 10E shows the shape of an analytic model.

The shape of a protrusion (elastic structure) 1005 disposed on the surface of the bonding member was defined as an inclined cylinder having a diameter of 10 μm and a height of 10 μm and an angle formed between the axis 1008 and the first direction 1001 was determined as 60 degrees.

The vertical cross section of the elastic structure has a parallelogrammatic shape and is left-right asymmetric.

The modulus of elasticity and the Poisson's ratio of the elastic structure were respectively defined as 0.29 MPa and 0.45.

The modulus of elasticity and the Poisson's ratio of the substrate were respectively defined as 80 GPa and 0.21. The substrate 1006 for the structure analysis was shaped in a cylinder having a diameter of 11 μm and a height of 1 μm.

The adhesive energy between the elastic structure 1005 and the substrate 1006 was defined as 7 mJ/m² on a first-direction half of the bottom face and as 70 mJ/m² on a second-direction half of the bottom face.

Thus, the adhesive energies Δγ1^{c,d} and Δγ2^{c,d} at the first release portion 1003 and the second release portion 1004 are determined as 70 mJ/m² and 7 mJ/m², respectively, and differ from each other.

The strain-energy-release rate G1^{c,d} at the first release portion when a force of 1 μN is exerted on the protrusion in the first direction is 1.7 mJ/m² whereas the strain-energy-release rate G2^{c,d} at the second release portion when a force of 1 μN is exerted on the protrusion in the second direction is 30 mJ/m².

Thus, G1^{c,d}/Δγ1^{c,d}=0.024, G2^{c,d}/Δγ2^{c,d}=4.3, and G1^{c,d}Δγ2^{c,d}/G2^{c,d}Δγ1^{c,d}=0.0055, whereby G1^{c,d}Δγ2^{c,d}/G2^{c,d}Δγ1^{c,d}≠1 is satisfied.

When the adhesive energy at the first release portion is assumed to be equal to the adhesive energy at the second release portion, Δγ1^{c-,d}=Δγ2^{c-,d}.

Since G1^{c-,d}=G1^{c,d}=1.7 mJ/m² and G2^{c-,d}=G2^{c,d}=30 mJ/m², G1^{c-,d}Δγ2^{c-,d}/G2^{c-,d}Δγ1^{c-,d}=0.055, whereby G1^{c,d}Δγ2^{c,d}/G2^{c,d}Δγ1^{c,d}<G1^{c-,d}Δγ2^{c-,d}/G2^{c-,d}Δγ1^{c-,d}<1 is satisfied.

Here, the adhesion force against a force exerted in the first direction is 1×(G1^{c,d}/Δγ1^{c,d})^{-1/2}=6.5 μN and the adhesion force against a force exerted in the second direction is 1×(G2^{c,d}/Δγ2^{c,d})^{-1/2}=0.48 Thus, the adhesion force has directional dependency. In this case, the adhesion force against a force exerted in the first direction is stronger than the adhesion force against a force exerted in the second direction.

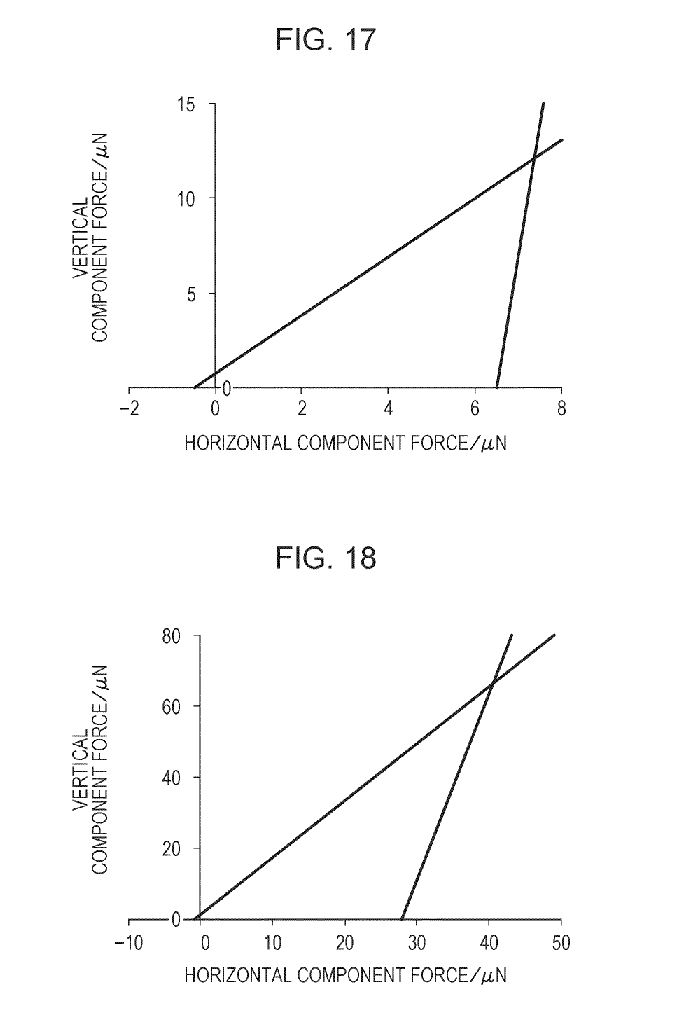

FIG. 17 shows the adhesion profile of the elastic structure.

Here, the level of the directional dependency of the adhesion force in this example is expressed by R=0.074, that is, the level of directional dependency is high. In the case where the adhesive energy at the first release portion is assumed to be equal to the adhesive energy at the second release portion, R={1×(G2^{c-,d}/Δγ2^{c-,d})^{-1/2}}/{1×(G1^{c-,d}/Δγ1^{c-,d})^{-1/2}}=0.23.

Specifically, varying the adhesive energy and making the vertical cross section asymmetric effectively enhance the directional dependency of the adhesion force.

Thus, in this example, the bonding member has adhesion force with a very high level of directional dependency with the synergy between the effect resulting from varying the adhesive energy between the protrusion and the substrate and the effect resulting from making the vertical cross section of the protrusion asymmetric.

### Reference Example 4

### Analysis on Adhesion Profile of Protrusion Having Varied Modulus of Elasticity, Asymmetric Horizontal Cross Section, and Asymmetric Vertical Cross Section

FIG. 10F shows the shape of an analytic model.

The shape of a protrusion (elastic structure) 1005 disposed on the surface of the bonding member was defined as an inclined triangular prism having a height of 10 μm and an angle formed between the axis 1008 and the first direction 1001 was determined as 60 degrees.

The protrusion has a horizontal cross section shaped in an isosceles triangle having a base of 10 μm and a height of 10 μm. In the cross section, the base of the isosceles triangle is perpendicular to the first direction and the vertex of the isosceles triangle is directed in the first direction.

The vertical cross section of the elastic structure has a parallelogrammatic shape and is left-right asymmetric.

The modulus of elasticity and the Poisson's ratio of the elastic structure were respectively defined as 29 MPa and 0.45 in a region 1007 located at the height from the bottom face in the range of 100 nm or higher and having a width of 5 μm from the outermost portion in the first direction.

The modulus of elasticity and the Poisson's ratio of the elastic structure in the remaining region were respectively defined as 0.29 MPa and 0.45. The modulus of elasticity and the Poisson's ratio of the substrate were respectively defined as 80 GPa and 0.21. The substrate 1006 for the structure analysis was shaped in a triangular prism having a height of 2 μm and having a cross section shaped in an isosceles triangle having a base of 11 μm and a height of 11 μm. The adhesive energy between the elastic structure and the substrate was defined as being uniform throughout the entire bottom face.

The strain-energy-release rate G1 at the first release portion 1003 of the elastic structure when a force of 1 μN is exerted on the elastic structure in the first direction was 0.090 mJ/m² whereas the strain-energy-release rate G2 at the second release portion 1004 of the elastic structure when a force of 1 μN is exerted on the elastic structure in the second direction 1002 was 97 mJ/m².

Here, G1/Δγ1=0.0013 and G2/Δγ2=1.4 in the case where the adhesive energies Δγ1 and Δγ2 at the first release portion and at the second release portion are 70 mJ/m². G1Δγ2/G2Δγ1=9.3×10⁻⁴, whereby G1Δγ2/G2Δγ1≠1 is satisfied.

Although not described in detail, in order that G1Δγ2/G2Δγ1 is further reduced provided that G1Δγ2/G2Δγ1<1, this example is formed so as to have an appropriate combination of three features of varying the modulus of elasticity, making the horizontal cross section asymmetric, and making the vertical cross section asymmetric.

The adhesion force against a force exerted in the first direction is 1×(G1/Δγ1)^{-1/2}=28 μN and the adhesion force against a force exerted in the second direction is 1×(G2/Δγ2)^{-1/2}=0.85 μN. Thus, the adhesion force has directional dependency. In this case, the adhesion force against a force exerted in the first direction is stronger than the adhesion force against a force exerted in the second direction.

FIG. 18 shows the adhesion profile of this elastic structure.

The level of the directional dependency of the adhesion force in this example is expressed by R=0.030, that is, the level of the directional dependency is high.

This is because, in this example, the three features of varying the modulus of elasticity, making the horizontal cross section asymmetric, and making the vertical cross section asymmetric are appropriately combined so that G1Δγ2/G2Δγ1 is further reduced provided that G1Δγ2/G2Δγ1<1. In other words, these features effectively enhance the directional dependency of the adhesion force.

Thus, in this example, the bonding member has adhesion force with a very high level of directional dependency with the synergy between the effect resulting from varying the modulus of elasticity of the protrusion, the effect resulting from making the horizontal cross section of the protrusion asymmetric, and the effect resulting from making the vertical cross section of the protrusion asymmetric.

### Example 6

### Analysis on Adhesion Profile of Protrusion Having Asymmetric Horizontal Cross Section, Varied Adhesive Energy, and Asymmetric Vertical Cross Section

The shape of the analytic model was the same as that of the analytic model used in Reference Example 3 (FIG. 10D).

The adhesive energy between the protrusion (elastic structure) 1005 and the substrate 1006 was defined as 7 mJ/m² on a first-direction half of the bottom face and as 70 mJ/m² on a second-direction half of the bottom face.

Thus, the adhesive energies Δγ1 and Δγ2 at the first release portion 1003 and the second release portion 1004 are determined as 70 mJ/m² and 7 mJ/m², respectively, and differ from each other.

Similarly to Reference Example 3, the strain-energy-release rate G1 at the first release portion of the protrusion when a force of 1 μN is exerted on the protrusion in the first direction is 7.0 mJ/m² whereas the strain-energy-release rate G2 at the second release portion of the protrusion when a force of 1 μN is exerted on the protrusion in the second direction is 290 mJ/m².

Thus, G1/Δγ1=0.10 and G2/Δγ2=41, and thus G1Δγ2/G2Δγ1=0.0024, whereby G1Δγ2/G2Δγ1≠1 is satisfied.

Although not described in detail, in order that G1Δγ2/G2Δγ1 is further reduced provided that G1Δγ2/G2Δγ1<1, this example is formed so as to have an appropriate combination of three features of making the horizontal cross section asymmetric, varying the adhesive energy, and making the vertical cross section asymmetric.

The adhesion force against a force exerted in the first direction is 1×(G1/Δγ1)^{-1/2}=3.2 μN and the adhesion force against a force exerted in the second direction is 1×(G2/Δγ2)^{-1/2}=0.16 μN. Thus, the adhesion force has directional dependency. In this case, the adhesion force against a force exerted in the first direction is stronger than the adhesion force against a force exerted in the second direction.

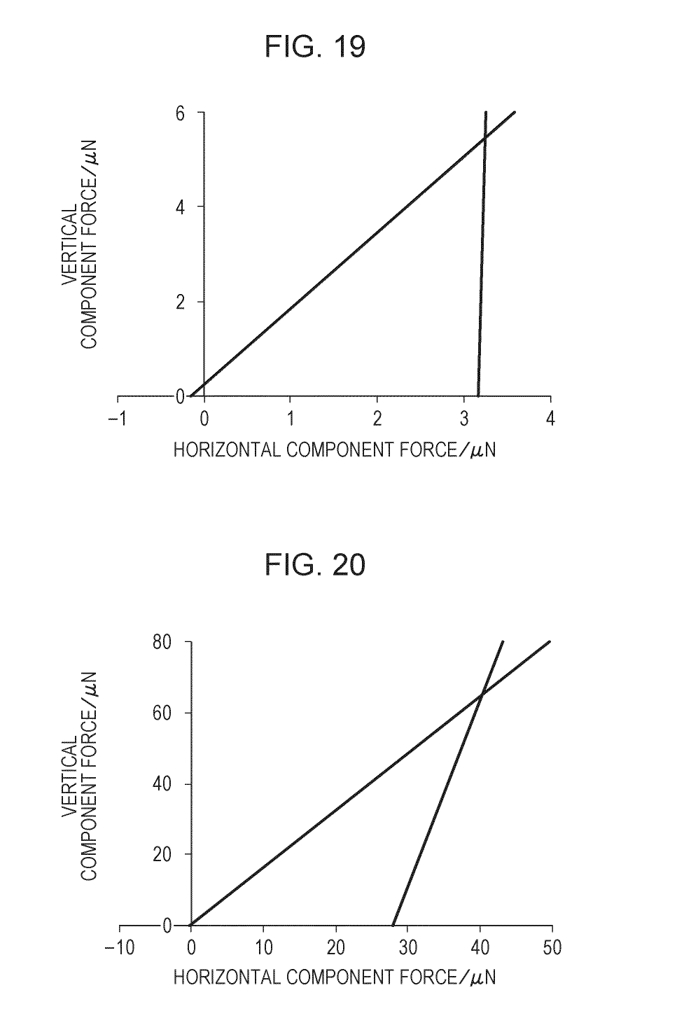

FIG. 19 shows the adhesion profile of this elastic structure.

The level of the directional dependency of the adhesion force in this example is expressed by R=0.049, that is, the level of the directional dependency is high.

This is because, in this example, the three features of making the horizontal cross section asymmetric, varying the adhesive energy, and making the vertical cross section asymmetric are appropriately combined so that G1Δγ2/G2Δγ1 is further reduced provided that G1Δγ2/G2Δγ1<1. In other words, these features effectively enhance the directional dependency of the adhesion force.

Thus, in this example, the bonding member has adhesion force with a very high level of directional dependency with the synergy between the effect resulting from making the horizontal cross section of the protrusion asymmetric, the effect resulting from varying the adhesive energy between the protrusion and the substrate, and the effect resulting from making the vertical cross section of the protrusion asymmetric.

### Example 7

### Analysis on Adhesion Profile of Protrusion Having Varied Modulus of Elasticity, Asymmetric Horizontal Cross Section, Varied Adhesive Energy, and Asymmetric Vertical Cross Section

The shape of the analytic model was the same as that of the analytic model used in Reference Example 4 (FIG. 10F).

The adhesive energy between the protrusion (elastic structure) 1005 and the substrate 1006 was defined as 7 mJ/m² on a first-direction half of the bottom face and as 70 mJ/m² on a second-direction half of the bottom face.

Thus, the adhesive energies Δγ1 and Δγ2 at the first release portion 1003 and the second release portion 1004 are determined as 70 mJ/m² and 7 mJ/m², respectively, and differ from each other.

Similarly to Reference Example 4, the strain-energy-release rate G1 at the first release portion of the protrusion when a force of 1 μN is exerted on the protrusion in the first direction is 0.090 mJ/m² whereas the strain-energy-release rate G2 at the second release portion of the protrusion when a force of 1 μN is exerted on the protrusion in the second direction is 97 mJ/m².

Thus, G1/Δγ1=0.0013 and G2/Δγ2=14, and thus G1Δγ2/G2Δγ1=9.3×10⁻⁵, whereby G1Δγ2/G2Δγ1≠1 is satisfied.

Although not described in detail, in order that G1Δγ2/G2Δγ1 is further reduced provided that G1Δγ2/G2Δγ1<1, this example is formed so as to have an appropriate combination of four features of varying the modulus of elasticity, making the horizontal cross section asymmetric, varying the adhesive energy, and making the vertical cross section asymmetric.

The adhesion force against a force exerted in the first direction is 1×(G1/Δγ1)^{-1/2}=28 μN and the adhesion force against a force exerted in the second direction is 1×(G2/Δγ2)^{-1/2}=0.27 μN. Thus, the adhesion force has directional dependency.

In this case, the adhesion force against a force exerted in the first direction is stronger than the adhesion force against a force exerted in the second direction.

FIG. 20 shows the adhesion profile of this elastic structure.

The level of the directional dependency of the adhesion force in this example is expressed by R=0.0096, that is, the level of the directional dependency is high.

This is because, in this example, the four features of varying the modulus of elasticity, making the horizontal cross section asymmetric, varying the adhesive energy, and making the vertical cross section asymmetric are appropriately combined so that G1Δγ2/G2Δγ1 is further reduced provided that G1Δγ2/G2Δγ1<1. In other words, these features effectively enhance the directional dependency of the adhesion force.

Thus, in this example, the bonding member has adhesion force with a high level of directional dependency with the synergy between the effect resulting from varying the modulus of elasticity of the protrusion, the effect resulting from making the horizontal cross section of the protrusion asymmetric, the effect resulting from varying the adhesive energy between the protrusion and the substrate, and the effect resulting from making the vertical cross section of the protrusion asymmetric.

### Example 8

Now, an example of a method for manufacturing a bonding member and an example of a method for measuring the adhesion force are described.

### Method for Manufacturing Bonding Member

The bonding member is manufactured by molding a polymer resin into an appropriate shape using a mold.

The method for manufacturing a mold is as follows. Firstly, a chrome photomask having a shape or a pattern corresponding to the shape or the pattern of the protrusion is manufactured on a glass wafer with a conventional method. Subsequently, a photoresist (product name of AZ P4620 from AZ Electronic Materials) is applied to the chrome surface by spin coating. Then, the photoresist is exposed to light from the glass-wafer side and developed by a conventional method, whereby a resist pattern serving as a mold is obtained.

The method for molding a polymer resin in a desired shape is as follows. A solution including the base of polydimethylsiloxane and a catalyst (product name Sylgard 184 from Dow Corning Toray, hereinafter referred to as PDMS) in a ratio of ten to one is applied to the resist pattern by spin coating and then subjected to thermal curing at 100 degrees for one hour. The resist is dissolved by acetone, the PDMS sheet is isolated, and the sheet is cleaned with acetone several times and dried in a vacuum.

The method for manufacturing a bonding member including a protrusion having a varied modulus of elasticity and/or a varied Poisson's ratio is as follows. Silica particles (product name MP-2040 from Nissan Chemical Industries, Ltd. and having a diameter of 200 nm) having a size smaller than the protrusion are subjected to surface treatment with triethoxyvinylsilane by a conventional method. Then, the vinyl group of the particle surface is treated with methylhydrosiloxane-dimethylsiloxane copolymer using a platinum complex catalyst. The particles thus obtained by the treatment are dispersed in di-n-butyl ether at a weight percent of 30%. This liquid in which the particles are dispersed is cast over the resist pattern and subjected to spin coating. This process enables silica particles to be disposed to one side in a cavity of the resist pattern. Subsequently, the solvent is removed from the resist pattern in a vacuum, and the resist pattern is used as a mold to mold a polymer resin into an appropriate shape in the above-described method, so that a bonding member including a protrusion containing silica particles is obtained. The protrusion manufactured by this method may have roughness at its end face. Thus, forming the end face of the protrusion by microcontact printing process using PDMS is also effective.

A bonding member including a protrusion having an asymmetric horizontal cross section is manufactured using a chrome photomask appropriate for forming an asymmetric shape in the above-described method for preparing a mold.

A bonding member having an asymmetric vertical cross section is manufactured by exposing a glass wafer to light cast in a direction obliquely to the glass wafer in the above-described method for preparing a mold.

The bonding member having a combination of features of a varied modulus of elasticity and an asymmetric vertical cross section can be formed by inclining the resist pattern when the liquid in which the particles are dispersed is cast over the resist pattern and subjected to spin coating, in such a manner that the axis of rotation in spin coating and the axis of the cavity corresponding to the protrusion are parallel to each other.

### Method for Measuring Adhesion Force of Bonding Member

The adhesion force of a single protrusion was evaluated using a measuring device that includes a two-axis drivable stage and a mechanism that detects deflection and torsion of a cantilever using an optical lever method. A glass ball having a diameter of 300 μm, which is sufficiently larger than the protrusion, is used as a substrate. A sample having a protrusion was installed on the stage and the glass ball was installed on the cantilever. The protrusion was pressed against the glass ball and moved in the vertical and horizontal directions at 0.5 μm/s. The vertical component force and the horizontal component force exerted between the protrusion and the glass ball during this movement were obtained through a conventional method using the amount of deflection and torsion of the cantilever. Since the forces are exerted between the protrusion and the glass ball while the protrusion is attached to the glass ball, the region including the measurement points is expressed in an adhesion profile.

The adhesion force of a bonding member including multiple protrusions was measured by a texture analyzer (TA.XT Plus from Stable Micro Systems Ltd.) using a flat glass plate as a substrate. This analyzer includes a one-axis force sensor and a one-axis drivable stage. The force that occurs when the bonding member is released from the substrate was measured while the angle between the axis of the sensor or the stage and the interface is changed. The size of the adhesive surface of the used bonding member was approximately one centimeter square. The adhesion profile was obtained by normalization by dividing the obtained adhesion force with the area of the adhesive surface, by dividing the normalized strength into the vertical component and the horizontal component, and by plotting the components.

In Reference Example 7 and Reference Example 11 described below, the adhesion force of a single protrusion and the adhesion force of a bonding member including multiple protrusions were both measured. These measurements have revealed that the adhesion force of a single protrusion and the adhesion force of a bonding member including multiple protrusions have similar directional dependency.

### Reference Example 5

### Actual Measurement Evaluation of Adhesion Profile of Protrusion Having Varied Modulus of Elasticity

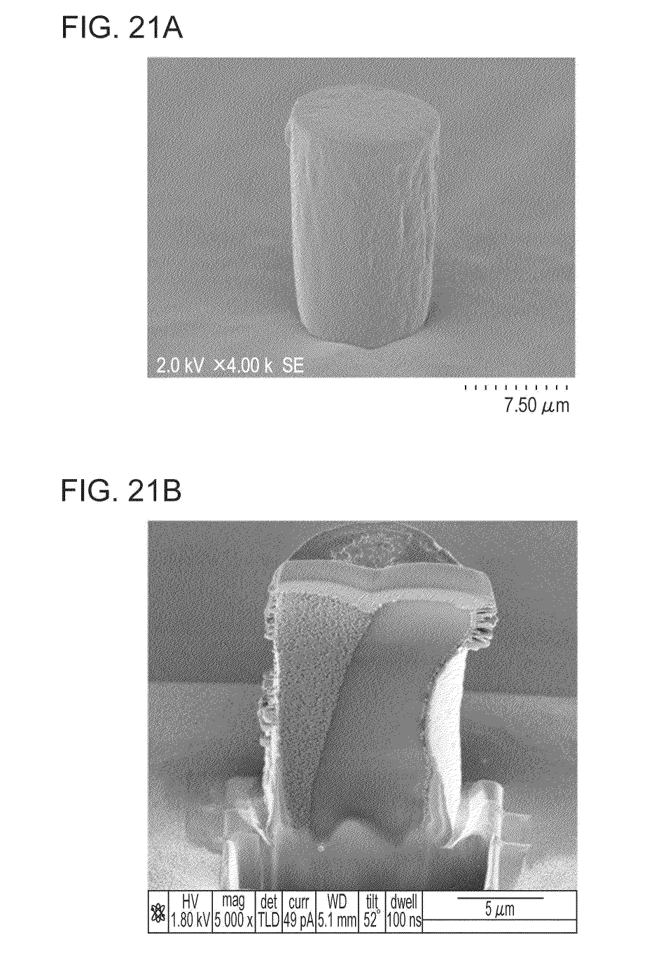

FIGS. 21A and 21B respectively show an observation image of the protrusion used for actual measurement evaluation observed through a scanning electron microscope (SEM) and a cross-sectional observation image observed through a focused ion beam (FIB)-SEM. FIGS. 21A and 21B show the state where silica particles are distributed so as to be disposed to one side. The modulus of elasticity of PDMS containing silica particles was 32 MPa and the modulus of elasticity of PDMS was 0.58 MPa, which were measured by using test samples separately prepared (the moduli of elasticity were similar in the following examples or reference examples). As described above, the protrusion has a varied modulus of elasticity. The shape of the whole body, the value of the modulus of elasticity, and the distribution state of the modulus of elasticity in the protrusion are approximate to those analyzed in Reference Example 1.

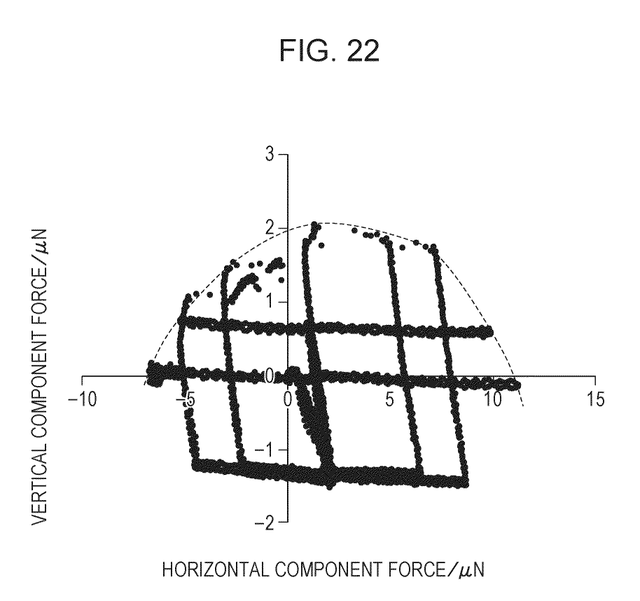

FIG. 22 shows the adhesion profile of the protrusion. The adhesion profile is asymmetric. As in the case of the analysis in Reference Example 1, the adhesion force is strong against a force that pulls the protrusion toward a side having a high modulus of elasticity. The absolute values of the adhesion force against forces exerted in the positive and negative horizontal directions were 11 μN and 6.8 μN, respectively, and the level of the directional dependency of the adhesion force was R=0.62.

Thus, in this example, the bonding member has adhesion force having directional dependency with the effect resulting from varying the modulus of elasticity of the protrusion.

### Reference Example 6

### Actual Measurement Evaluation of Adhesion Profile of Protrusion Having Asymmetric Horizontal Cross Section

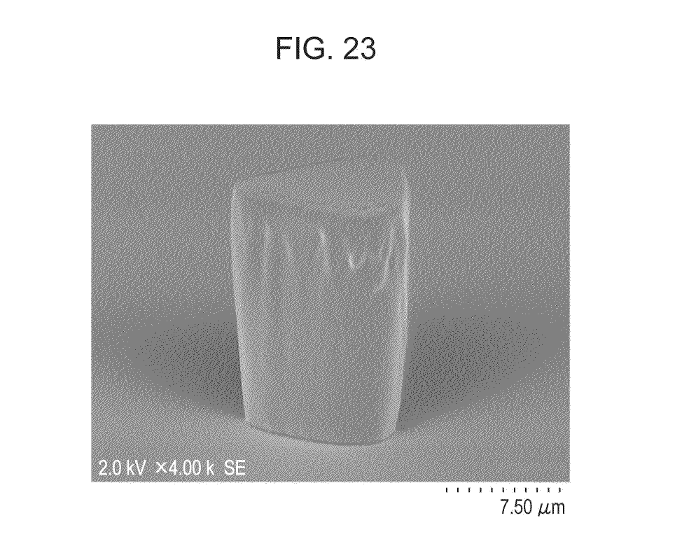

FIG. 23 shows an observation image of a protrusion used for actual measurement evaluation observed through a SEM. The horizontal cross section of the protrusion has an isosceles triangle shape and the entire shape is approximate to that analyzed in Reference Example 2.

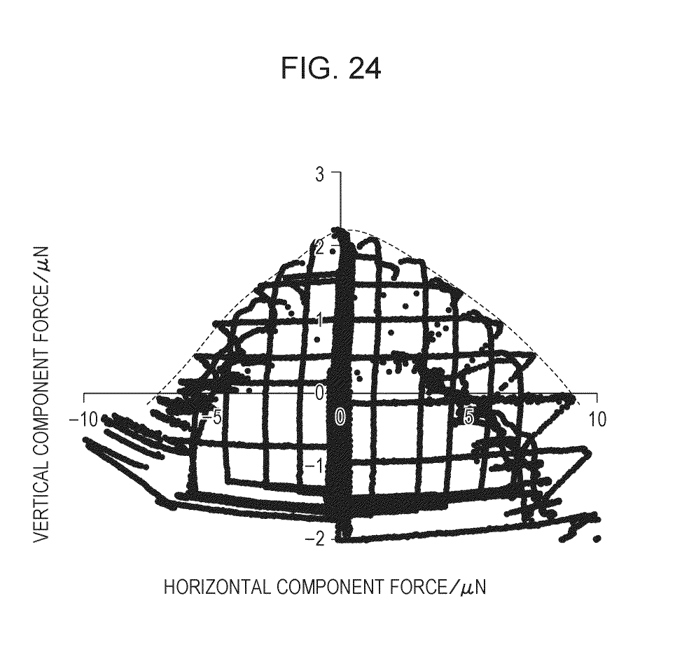

FIG. 24 shows the adhesion profile of the protrusion. The adhesion profile is asymmetric. Here, as in the case of the analysis in Reference Example 2, the adhesion force is strong against a force that pulls the protrusion toward the vertex of the isosceles triangle. The absolute values of the adhesion force against forces exerted in the positive and negative horizontal directions were 9.0 μN and 6.9 μN, respectively, and the level of the directional dependency of the adhesion force was R=0.77.

Thus, in this example, the bonding member has adhesion force having directional dependency with the effect resulting from making the horizontal cross section of the protrusion asymmetric.

### Reference Example 7

### Actual Measurement Evaluation of Adhesion Profile of Protrusion Having Asymmetric Vertical Cross Section

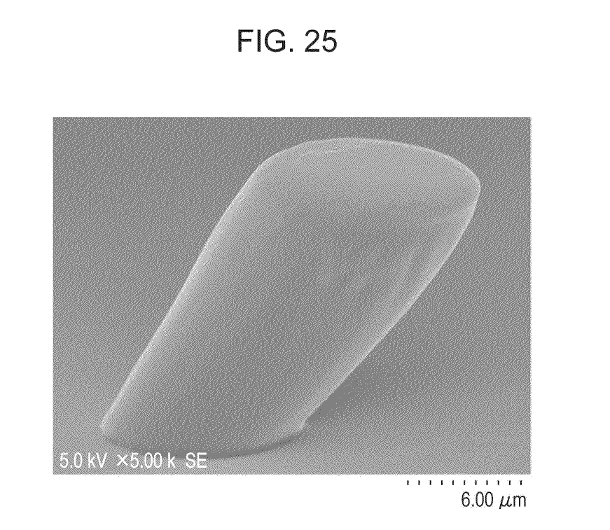

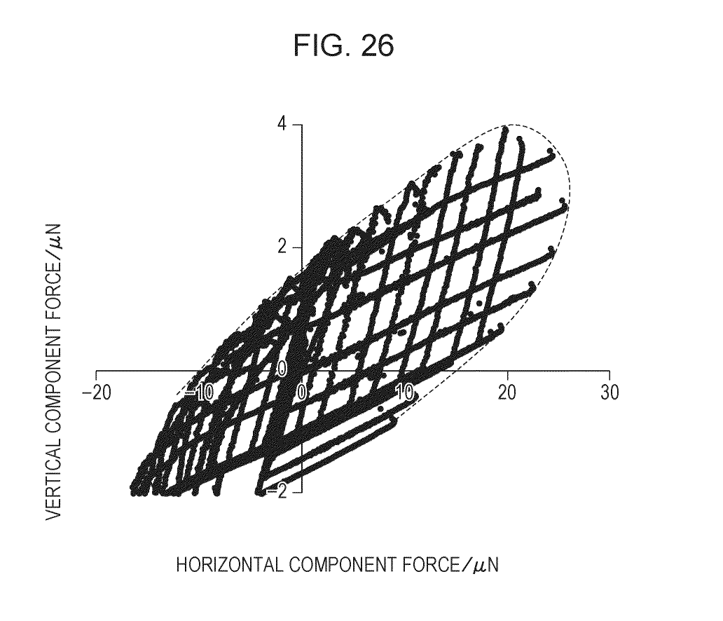

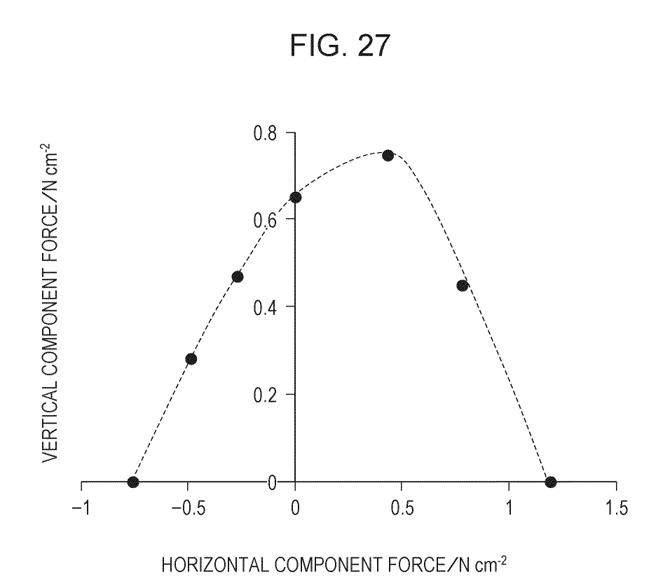

FIG. 25 shows an observation image of the protrusion used for actual measurement evaluation observed through a SEM. The protrusion has an inclined axis and an asymmetric vertical cross section. FIG. 26 shows the adhesion profile of the protrusion. The adhesion profile is asymmetric. Here, the adhesion force is strong against a force that pulls the protrusion in the axis direction. The absolute values of the adhesion force against forces exerted in the positive and negative horizontal directions were 15 μN and 9.4 μN, respectively, and the level of the directional dependency of the adhesion force was R=0.63.

FIG. 27 shows the adhesion profile of a bonding member including such protrusions arranged at a pitch of 25 μm. The adhesion profile is asymmetric. Here, the adhesion force is strong against a force that pulls the protrusion in the axis direction. The absolute values of the adhesion strength against forces exerted in the positive and negative horizontal directions were 1.2 N/cm² and 0.76 N/cm², respectively, and the level of the directional dependency of the adhesion force was R=0.64.

As described above, the level of the directional dependency of the adhesion force of the bonding member including multiple protrusions directly reflects the level of the directional dependency of the adhesion force of a single protrusion.

### Reference Example 8

### Actual Measurement Evaluation of Adhesion Profile of Protrusion Having Varied Modulus of Elasticity and Asymmetric Horizontal Cross Section

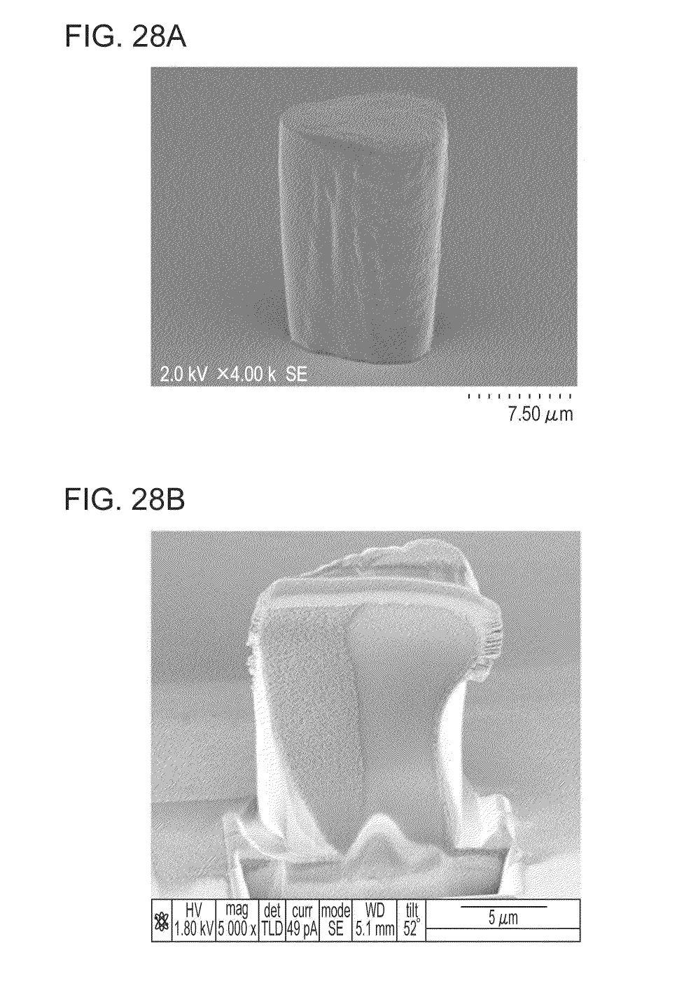

FIGS. 28A and 28B respectively show an observation image of a protrusion used for actual measurement evaluation observed through a SEM and a cross-sectional observation image of the protrusion observed through a FIB-SEM. FIGS. 28A and 28B show the state where silica particles are distributed so as to be disposed to one side. The horizontal cross section of the protrusion has an isosceles triangle shape.

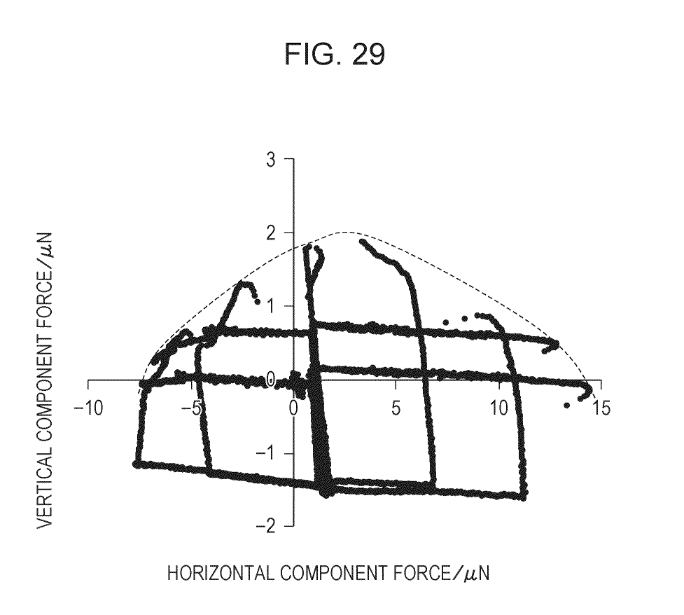

FIG. 29 shows the adhesion profile of the protrusion. The adhesion profile is asymmetric. Here, the adhesion force is strong against forces that pull the protrusion toward a side having a high modulus of elasticity and toward the vertex of the isosceles triangle. The absolute values of the adhesion force against forces exerted in the positive and negative horizontal directions were 14 μN and 7.4 μN, respectively, and the level of the directional dependency of the adhesion force was R=0.53. As described above, the degree of asymmetry of the adhesion profile is larger than that in the case of Reference Example 5 or Reference Example 6.

Thus, in this example, the bonding member has adhesion force having directional dependency with the synergy between the effect resulting from varying the modulus of elasticity of the protrusion and the effect resulting from making the horizontal cross section of the protrusion asymmetric.

### Reference Example 9

### Actual Measurement Evaluation of Adhesion Profile of Protrusion Having Varied Modulus of Elasticity and Asymmetric Vertical Cross Section

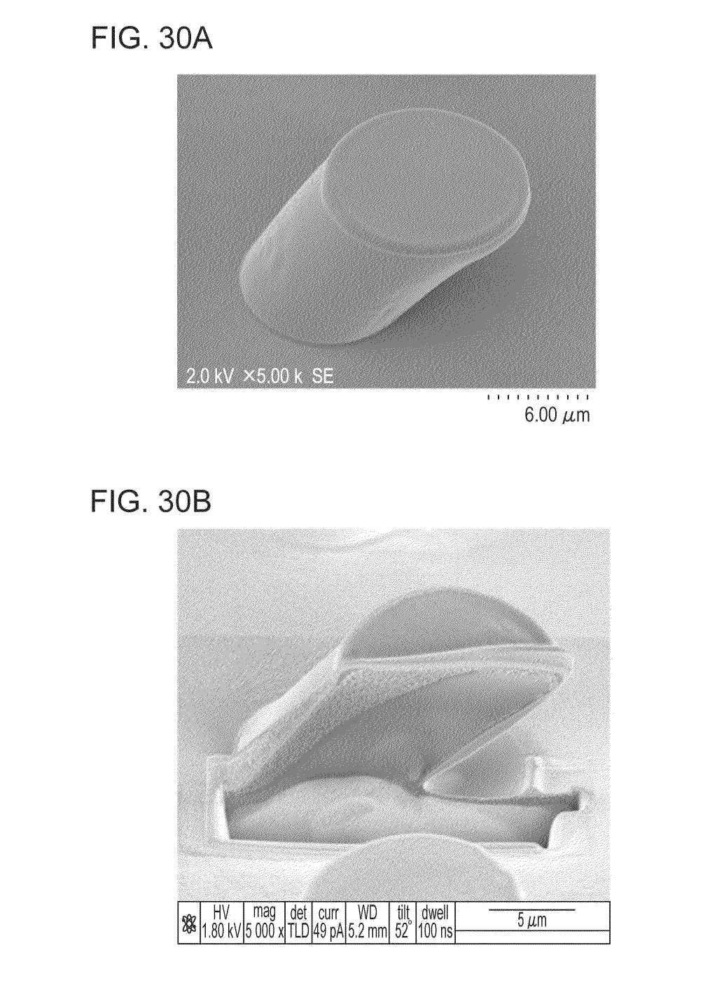

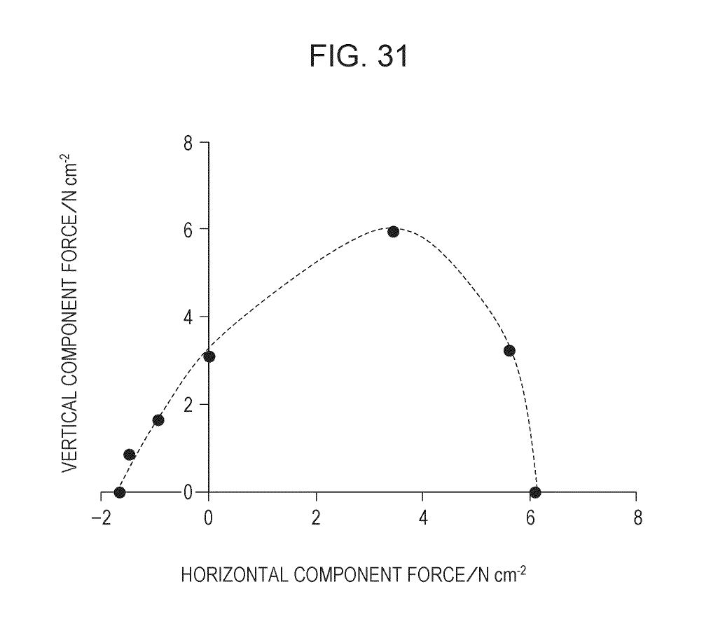

FIGS. 30A and 30B respectively show an observation image of a protrusion used for actual measurement evaluation observed through a SEM and a cross-sectional observation image of the protrusion observed through a FIB-SEM. FIGS. 30A and 30B show the state where the silica particles are distributed so as to be disposed to one side along the axis of the protrusion. The protrusion has an inclined axis and an asymmetric vertical cross section.

FIG. 31 shows the adhesion profile of a bonding member including such protrusions arranged at a pitch of 25 μm. The adhesion profile is asymmetric. Here, the adhesion force is strong against forces that pull the protrusion toward a side having a high modulus of elasticity and in the direction parallel to the axis. The absolute values of the adhesion strength against forces exerted in the positive and negative horizontal directions were 6.1 N/cm² and 1.7 N/cm², respectively, and the level of the directional dependency of the adhesion force was R=0.28. As described above, the degree of asymmetry of the adhesion profile is larger than that in the case of Reference Example 5 or Reference Example 7.

Thus, in this example, the bonding member has adhesion force having directional dependency with the synergy between the effect resulting from varying the modulus of elasticity of the protrusion and the effect resulting from making the vertical cross section of the protrusion asymmetric.

### Reference Example 10

### Actual Measurement Evaluation of Adhesion Profile of Protrusion Having Asymmetric Horizontal Cross Section and Asymmetric Vertical Cross Section

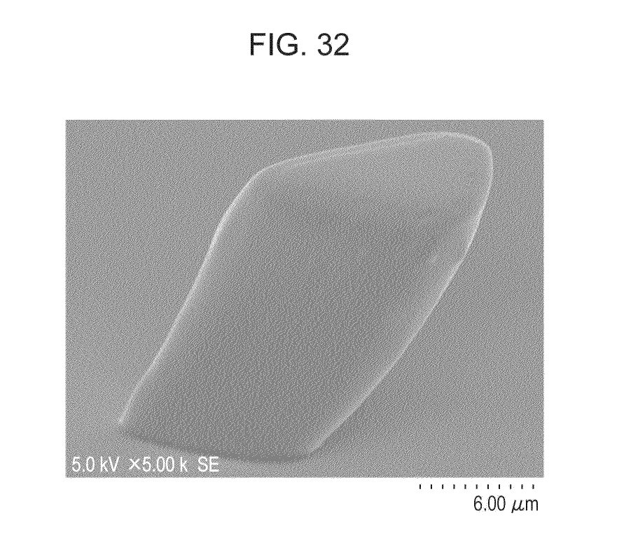

FIG. 32 shows an observation image of a protrusion used for actual measurement evaluation observed through a SEM. The horizontal cross section of the protrusion has an isosceles triangle shape. The protrusion has an inclined axis and an asymmetric vertical cross section. The shape of the entire protrusion is similar to that analyzed in Reference Example 3.

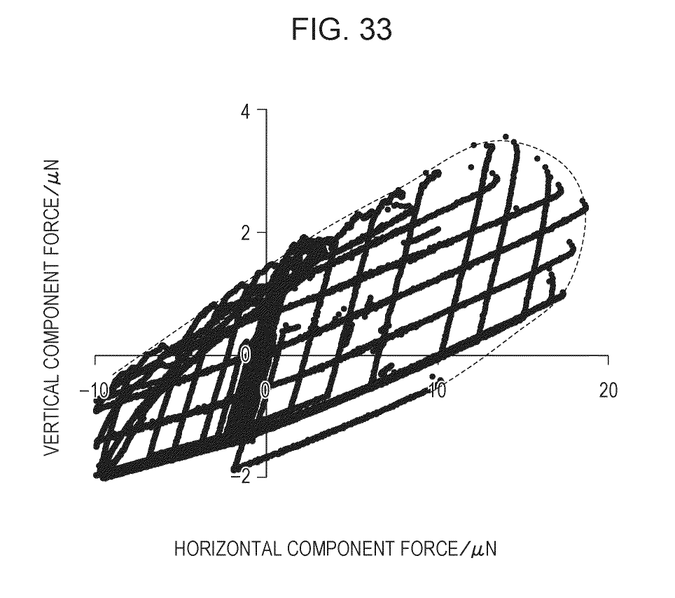

FIG. 33 shows the adhesion profile of the protrusion. The adhesion profile is asymmetric. As in the case of the analysis in Reference Example 3, the adhesion force is strong against forces that pull the protrusion toward the vertex of the isosceles triangle and in the direction parallel to the axis. The absolute values of the adhesion force against forces exerted in the positive and negative horizontal directions were 13 μN and 7.0 μN, respectively, and the level of the directional dependency of the adhesion force was R=0.54. As described above, the degree of asymmetry of the adhesion profile is larger than that in the case of Reference Example 6 or Reference Example 7.

Thus, in this example, the bonding member has adhesion force having a higher level of directional dependency with the synergy between the effect resulting from making the horizontal cross section of the protrusion asymmetric and the effect resulting from making the vertical cross section of the protrusion asymmetric.

### Reference Example 11

### Actual Measurement Evaluation of Adhesion Profile of Protrusion Having Varied Modulus of Elasticity, Asymmetric Horizontal Cross Section, and Asymmetric Vertical Cross Section

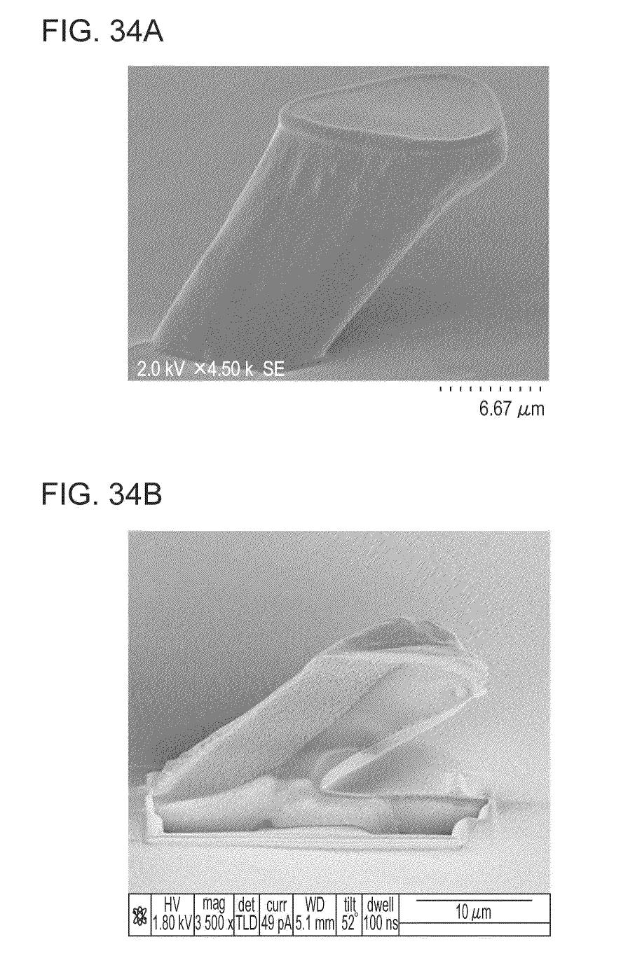

FIGS. 34A and 34B respectively show an observation image of a protrusion used for actual measurement evaluation observed through a SEM and a cross-sectional observation image of the protrusion observed through a FIB-SEM. FIGS. 30A and 30B show the state where the silica particles are distributed so as to be disposed to one side along the axis of the protrusion. The horizontal cross section of the protrusion has an isosceles triangle shape. The protrusion has an inclined axis and an asymmetric vertical cross section. The shape of the entire body, the value of the modulus of elasticity, and the distribution state of the modulus of elasticity in the protrusion are similar to those analyzed in Reference Example 4.

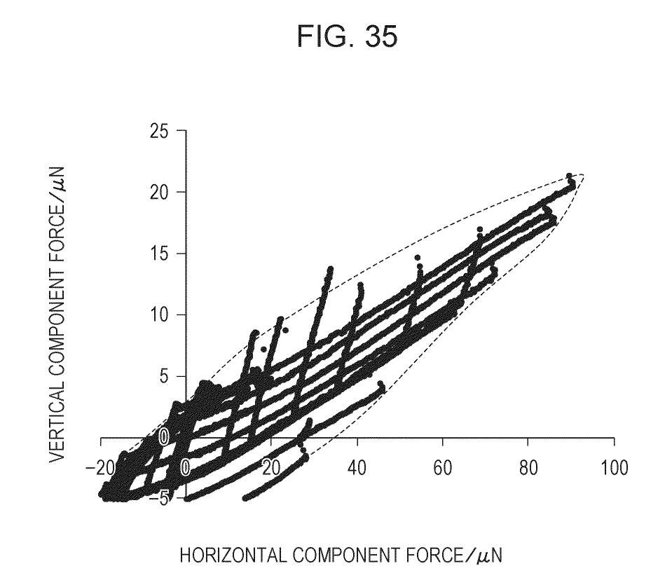

FIG. 35 shows the adhesion profile of the protrusion. The adhesion profile is asymmetric. As in the case of the analysis in Reference Example 4, the adhesion force is strong against forces that pull the protrusion toward a side having a high modulus of elasticity, toward the vertex of the isosceles triangle, and in the direction parallel to the axis. The absolute values of the adhesion force against forces exerted in the positive and negative horizontal directions were 34 μN and 8.9 μN, respectively, and the level of the directional dependency of the adhesion force was R=0.26. As described above, the degree of asymmetry of the adhesion profile is larger than that in the case of Reference Example 8, Reference Example 9, or Reference Example 10.

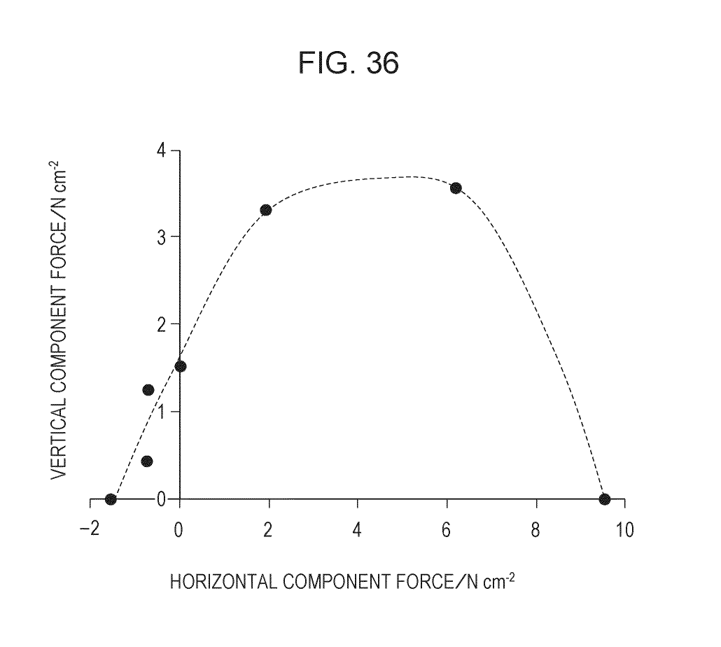

FIG. 36 shows the adhesion profile of a bonding member including such protrusions arranged at a pitch of 25 μm. The adhesion profile is asymmetric. Here, the adhesion force is strong against forces that pull the protrusion toward a side having a high modulus of elasticity, toward the vertex of the isosceles triangle, and in the direction parallel to the axis. The absolute values of the adhesion strength against forces exerted in the positive and negative horizontal directions were 9.5 N/cm² and 1.6 N/cm², respectively, and the level of the directional dependency of the adhesion force was R=0.16. As described above, the degree of asymmetry of the adhesion profile in the bonding member is also larger than that in the case of Reference Example 8, Reference Example 9, or Reference Example 10.

Thus, in this example, the bonding member has adhesion force with an extremely high level of directional dependency with the synergy between the effect resulting from varying the modulus of elasticity of the protrusion, the effect resulting from making the horizontal cross section of the protrusion asymmetric, and the effect resulting from making the vertical cross section of the protrusion asymmetric.

The invention provides a bonding member having adhesion force with a relatively high level of directional dependency so that the adhesion force against a force exerted in a first direction can differ from the adhesion force against a force exerted in a second direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-074573, filed Mar. 31, 2014, which is hereby incorporated by reference herein in its entirety.

What is claimed is:

1. A bonding member, comprising:
a base; and
a protrusion that protrudes from a surface of the base and that has an end face that adheres to a substrate with a surface force between the end face and the substrate,
wherein Δγ1^{c} and Δγ2^{c} differ from each other so as to satisfy a relationship G1^{c}/Δγ1^{c}≠G2^{c}/Δγ2^{c}, where G1^{c} denotes a strain-energy-release rate at a first release portion of the protrusion when a force is exerted on the protrusion in a first direction parallel to the surface, Δγ1^{c} denotes an adhesive energy at the first release portion, G2^{c} denotes a strain-energy-release rate at a second release portion of the protrusion when a force having the same magnitude as the force exerted in the first direction is exerted on the protrusion in a second direction opposite to the first direction, and Δγ2^{c} denotes an adhesive energy at the second release portion.

2. The bonding member according to claim 1, comprising a plurality of the protrusions.

3. The bonding member according to claim 1, wherein the strain-energy-release rates G1^{c} and G2^{c} and the adhesive energies Δγ1^{c} and Δγ2^{c} satisfy a relationship G1^{c}<G2^{c} and Δγ1^{c}>Δγ2^{c} or G1^{c}>G2^{c} and Δγ1^{c}<Δγ2^{c}.

4. The bonding member according to claim 1, wherein the strain-energy-release rates G1^{c} and G2^{c} satisfy a relationship G1^{c}≧G2^{c} and an adhesive energy Δγ^{c} at any point on the end face satisfies a relationship Δγ1^{c}≦Δγ^{c} and/or Δγ2^{c}≧Δγ^{c}.

5. The bonding member according to claim 1, wherein the strain-energy-release rates G1^{c} and G2^{c} satisfy G1^{c}≦G2^{c} and an adhesive energy Δγ^{c} at any point on the end face satisfies a relationship Δγ1^{c}≧Δγ^{c} and/or Δγ2^{c}≦Δγ^{c}.

6. The bonding member according to claim 1, wherein the protrusion has a columnar shape.

7. The bonding member according to claim 1, wherein the end face has two regions having substantially equal adhesive energies, the adhesive energy in a region including the first release portion is Δγ1^{c}, and the adhesive energy in a region including the second release portion is Δγ2^{c}.

8. A bonding member, comprising:
a base; and
a protrusion that protrudes from a surface of the base and that has an end face that adheres to a substrate with a surface force between the end face and the substrate,
wherein the protrusion has a left-right asymmetric cross section taken along a plane perpendicular to the surface and parallel to a first direction,
wherein Δγ1^{c,d} and Δγ2^{c,d} differ from each other and the bonding member satisfies a relationship G1^{c,d}/Δγ^{b,d}≠G2^{c,d}/Δγ2^{c,d}, where G1^{c,d} denotes a strain-energy-release rate at a first release portion of the protrusion when a force is exerted on the protrusion in the first direction parallel to the surface, Δγ1^{c,d} denotes an adhesive energy at the first release portion, G2^{c,d} denotes a strain-energy-release rate at a second release portion of the protrusion when a force having the same magnitude as the force exerted in the first direction is exerted on the protrusion in a second direction opposite to the first direction, and Δγ2^{c,d} denotes an adhesive energy at the second release portion, and
wherein the bonding member satisfies a relationship G1^{c,d}Δγ2^{c,d}/G2^{c,d}Δγ1^{c,d}<G1^{c-,d}Δγ2^{c-,d}/G2^{c-,d}Δγ1^{c-,d}<1 or G1^{c,d}Δγ2^{c,d}/G2^{c,d}Δγ1^{c,d}>G1^{c-,d}Δγ2^{c-,d}/G2^{c-,d}Δγ1^{c-,d}>1 where, provided that Δγ1^{c,d} and Δγ2^{c,d} are assumed to be equal, the strain-energy-release rate G1^{c,d} is denoted by G1^{c-,d}, the adhesive energy Δγ1^{c,d} is denoted by Δγ1^{c-,d}, the strain-energy-release rate G2^{c,d} is denoted by G2^{c-,d}, and the adhesive energy Δγ2^{c,d} is denoted by Δγ2^{c-,d}.

9. A method for manufacturing a bonding member including a base and a protrusion that protrudes from a surface of the base and that has an end face that adheres to a substrate with a surface force between the end face and the substrate, the method comprising:
differentiating Δγ1^{c} from Δγ2^{c} so that a relationship G1^{c}/Δγ1^{c}≠G2^{c}/Δγ2^{c} is satisfied, where G1^{c} denotes a strain-energy-release rate at a first release portion of the protrusion when a force is exerted on the protrusion in a first direction parallel to the surface, Δγ1^{c} denotes an adhesive energy at the first release portion, G2^{c} denotes a strain-energy-release rate at a second release portion of the protrusion when a force having the same magnitude as the force exerted in the first direction is exerted on the protrusion in a second direction opposite to the first direction, and Δγ2^{c} denotes an adhesive energy at the second release portion.
